(19) United States
(12) Patent Application Publication
(10) Pub. No.: US 2004/0139315 A1
(43) Pub. Date: Jul. 15, 2004

(54) Private data protection distribution method and program

(75) Inventors: Takashi Tokutani, Kawasaki (JP); Takahisa Hatakeyama, Kawasaki (JP); Hiroshi Matsunaga, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/679,647

(22) Filed: Oct. 6, 2003

(30) Foreign Application Priority Data
Oct. 9, 2002 (JP) 2002-296778

(51) Int. Cl. H04L 9/00

(52) U.S. Cl. 713/156; 705/59

(57) ABSTRACT

An information entity transmits encrypted private data to a computer of a service provider, which makes a request to use private data, by using a client tool. Additionally, the information entity creates by using the client tool a decryption key for decrypting the private data, and a private data use license which includes information stipulating a use condition of the private data, such as a use purpose, the number of use times, an expiry date, the number of times that a move can be made, and the like, and transmits the decryption key and the license to the computer of the service provider by using a DRM authentication technology. The service provider can use the private data only if its use purpose matches the use condition described in the private data use license created by the information entity.

### BACKGROUND OF THE INVENTION

1. Field of the Invention

The present invention relates to a private data protection distribution system restricting the use of private information from an information entity for a private information handling provider that obtains private information from the information entity, and uses the private information.

2. Description of the Related Art

In recent years, attention has been focused on the handling of private information, such as a privacy mark system, private information guidelines submitted from various ministries and agencies, a privacy protection bill, P3P laid down by W3C, and the like.

W3C (World Wide Web consortium) is a non-profit organization established to lay down various types of standard specifications of services available on the Internet in Massachusetts Institute of Technology, Laboratory for Computer Science in 1994. W3C has laid down various Internet standards such as HTML, XML, etc. Furthermore, P3P (Platform for Privacy Preferences) is a standard format for describing the privacy policy of a Web site, and is currently being standardized by W3C. With this format, agent software on a user side automatically obtains and interprets the privacy policy of a corresponding Web site, and checks the privacy policy against a handling standard of private information, which is preset by a user, so that the agent software can switch its behavior.

For example, not a few cases exist where a user who accesses a site is identified, and his or her behavior is monitored with Cookie, even if not requiring a elaborated Web site . Conventionally, to verify with which policy private information acquired by a Web site side is used, a user itself must examine the privacy policy of each site. P3P is devised to describe the privacy policy of a site in a standard format so that software can automatically execute such a process. With P3P, a user presets a handling standard of private information by using a Web browser, etc., so that whether or not the privacy policy of a Web site deviates from this standard can be automatically determined.

As descried above, P3P provides a technical mechanism for making software automatically obtain and interpret the privacy policy of an accessed Web site. However, since P3P does not guarantee that a Web site is operated in accordance with a described policy, caution must be taken. Additionally, for P3P itself, means for safely transferring private information between a user and a Web site is not laid down. To safely transfer data, a different means must be taken.

Especially, according to a consciousness survey conducted by Harris Interactive Inc. in the US, “an enterprise shares private information with other enterprises without permission” is cited as the biggest concern of consumers among concerns of general consumers about private information. Additionally, an item such that the private information of a customer is not disclosed without permission of the customer or unless otherwise requested by law is cited as the top item on which consumers place prime importance to determine whether or not an enterprise is trustworthy.

Accordingly, it is important to prohibit at least the secondary use of private information or its use outside purpose, and to grasp and control, by an individual, (a control right of an information entity) where and how the private information of the individual is used so that an individual provides his or her private information without anxiety.

Furthermore, importance is placed on safe management and safe collection of private data by a provider in addition to the above described three points also in various guideline such as guidelines of various ministries and agencies, JIS Q 15001 being Japan Industrial Standard, the privacy protection bill (which is a bill as of April 2002), etc., an accreditation and evaluation system, and law.

In summary, at least the following five prerequisites must be satisfied to protect private data.

(1) A provider must notify an information entity of the use purpose of private data, and must use the private data within the scope of the purpose (prohibition of use outside purpose/illegal use).

(2) A provider must not illegally provide private data (prohibition of illegal provision/secondary use).

(3) A provider must safely store/manage private data (safe storage/management).

(4) A provider must safely collect private data (safe collection).

(5) A provider must disclose, correct, or delete private data of an information entity for the information entity if a request is made (securing of a control right of an information entity).

Conventionally, the following measures are taken.

(1) Private information management stipulations are laid down and complied with within an enterprise.

(2) Likewise (1), private information management stipulations are laid down and complied with within an enterprise. For example, a right to access a database which stores private data is given only to a particular employee.

(3) The following measures are taken.

(i) Private data is stored in a place to which an external access cannot be made.

(ii) Private data is stored, for example, by being encoded.

(iii) The legality of an individual who makes an access is determined by means of password authentication, and to which file an access can be made is controlled by means of role-based access control (control based on a job title, etc.) thereafter.

(iv) Who makes which access is logged.

(v) Data is backed up. A backed-up medium, etc. is stored, for example, in a locker locked up.

(4) Private data is provided by winning consent from an information entity beforehand. At that time, the private data is transmitted via an encrypted communication, etc.

(5) An account is obtained on a site, and an information entity is allowed to verify, correct, or delete his or her own private data on the site.

Additionally, in a currently provided service that handles private information, center centralized management such that a center collects private data from individual users, and uses the private data exists. For the use of private data in such a service, by way of example, a center collects information of an interested field from individual users, makes a contract with an enterprise in that field, and makes an advertisement as an agent. In such a conventional form of centralized management, no cases exist where a center manages private information, and provides private data to a third party.

Furthermore, a technology called DRM (Digital Rights Management) has been recently used for copyright protection, although this is not intended for private information protection. DRM is composed of a use permission condition, and a mechanism which operates in accordance with the condition. Examples of the use permission condition include the number of use times, an expiry date, the number of copy times.

As conventional efforts to protect the privacy of electronic data, there is a technology with which a user can specify whether or not to accept a digital object or an executable file of Cookie, etc. (see Japanese Patent Application Publication tokuhyou No. HEI 10-512074(specification of U.S. Pat. No. 6,363,488))

Additionally, there is a technology having a configuration such that a private information management center acts as an intermediary between a private information provider and a private information user (see Japanese Patent Application Publication No. 2001-265771).

1) An illegal use such that a person who has a legal access right can copy, tamper, or delete information freely in the measures of (2) and (3) (iii), which are cited in the prior art for the private information protection.

2) For the measure of (1) cited in the prior art, only a measure using rules of conduct such as a private information stipulation is taken for a person who have a legal access right in terms of use within the scope of purpose, and no measures using an information processing technology actually exist for a use outside purpose.

3) A solution to the prerequisite (5) cited in the prior art is a solution with which only a center holds and manages private data. Accordingly, there are no measures to disclose, correct or delete private data in an environment where private data are scattered, after the center provides private data to a third party.

4) In a service for handling private information by means of the center centralized management, a center provides private data only to a provider, and does not provide private data to a third party so far. Accordingly, the provider to which the data is provided can possibly provide the private data to a different provider in an illegal manner.

### SUMMARY OF THE INVENTION

An object of the present invention is to provide a private information protection distribution system in which distribution of private information can be controlled in accordance with the intention of an information entity under the control of the information entity.

A private data protection distribution method according to the present invention comprises: receiving encrypted private data; receiving an encrypted private data use license which describes a decryption key for decrypting the private data, and a use condition of the private data; decrypting the decryption key and the private data use license; determining whether or not a use purpose of the private data matches the use condition described in the private data use license; and decrypting the private data by using the decrypted decryption key only if the use purpose of the private data matches the use condition.

Therefore, according to the present invention, a provider of private data (information entity) can restrict a private data use method of a party that obtains private data by creating a private data use license by the information entity itself. Accordingly, the private data of the provider is distributed under the control of the provider of the private data, whereby the provider of the private data can prevent its own private data from being illegally used in an unexpected place.

### BRIEF DESCRIPTION OF THE DRAWINGS

FIG. 1 explains the relationship among an information entity, a provider, and a third party;

FIG. 2 explains a rough configuration of a preferred embodiment according to the present invention;

FIG. 3 shows a mechanism for providing private information when an information entity consents to provide private information, and a mechanism with which a service provider uses the private information;

FIG. 4 explains the relationship between a use condition and the use of private data;

FIG. 5 explains DRM authentication;

FIG. 6 is a flowchart when a private data use license is transmitted by a client tool;

FIG. 7 explains the relationship between private data and a private data use license;

FIG. 8 is a flowchart when private data is used by an application;

FIG. 9 is a flowchart when a license is transmitted by a license database system;

FIG. 10 explains an example where another configuration of a preferred embodiment according to the present invention is applied;

FIG. 11 shows a mechanism for a disclosure when a disclosure request is made from an information entity;

FIG. 12 explains the operations executed when a request to correct private data is made from an information entity;

FIG. 13 is a flowchart showing a process for correcting private data, which is executed on a service provider side;

FIG. 14 explains a process for deleting private data, which is executed by a proxy license providing server;

FIG. 15 explains a process for generating a name list license;

FIG. 16 schematically shows a process for creating a name list, and a name list license;

FIG. 17 is a flowchart showing a process for creating a name list and a name list license, which is executed by a name list creation tool;

FIG. 18 explains a form where a name list is used;

FIG. 19 explains a process of a correction request when a name list is used;

FIG. 20 is a flowchart showing a process for correcting a name list, which is executed by a service provider when a name list is used;

FIG. 21 shows a process for transacting private data, which is executed between service providers;

FIG. 22 is a flowchart showing a process executed by a client tool when a private data use license is issued to a service provider B;

FIG. 23 explains a process of a disclosure request made to a service provider B when private data is transacted between service providers;

FIG. 24 explains a process of a correction request when private data is transacted between service providers;

FIG. 25 is a flowchart showing a synchronization process for maintaining the sameness of private data between service providers;

FIG. 26 explains a process of a correction request when a name list is used;

FIG. 27 is a flowchart showing a process of a correction request, which is executed by a service provider A when a name list is used;

FIG. 28 exemplifies a configuration of a center type private data provision system;

FIG. 29 is a flowchart showing a process executed by a search tool;

FIG. 30 explains a process for making a registration to a center;

FIG. 31 explains a process for providing private data;

FIG. 32 is a flowchart showing a provision process executed by a center;

FIG. 33 is a flowchart showing a process executed by a name list creation tool;

FIG. 34 shows the outline of creation of a name list license to be provided;

FIG. 35 explains the flow of a process of a correction request;

FIG. 36 is a flowchart showing a correction synchronization process which is executed by a service provider when a name list is used;

FIG. 37 explains a process for deleting private data possessed by a service provider;

FIG. 38 explains a process for deleting private data possessed by a center;

FIG. 39 shows the relationship among an information entity, a center, and a provider in one form of center type business; and

FIG. 40 shows a data flow.

### DESCRIPTION OF THE PREFERRED EMBODIMENTS

Preferred embodiments according to the present invention adopt the following configuration.

1) For the prohibition of an illegal use, only a DRM (Digital Rights Management) implemented as a TRM (Tamper Resistant Module) is allowed to use private data, so that tampering and deletion of the private data are prohibited. At this time, the number of times that a move can be made, which is decremented by 1 each time a move is made to the DRM device implemented as a TRM, is further provided as a use condition of a use license, and a condition which allows a copy is not provided or set to 0 if it is provided, thereby prohibiting an illegal copy.

2) Use outside purpose is solved by a condition that is the use purpose of a use license. Specifically, applications using private data are classified by use purpose, use purposes of the respective applications are made identifiable, and a DRM mechanism that is available only to an application which satisfies the use condition of a use license when the private data is used is comprised.

3) A request to disclose private data, which is made from an information entity, is implemented by a disclosure request made to a center (one type of a provider whose main service is the management of private data) . For other providers to which the center provides private data, a list that is created by the center and indicates to which providers private data is provided is provided to the information entity, whereby the information entity can make a disclosure request to all of the providers that hold the private data of the information entity.

A request to correct private data is solved in a way such that an information entity makes a request to correct private data to a center, and corrected information of the private data after the correction is synchronized among providers (here, the synchronization indicates an update of private data for respective providers so that the respective providers possess the same private data).

A request to delete private data is solved in a way such that an information entity identifies a provider where the information entity desires to make a deletion from a name list which describes private data, and the private data of the information entity is deleted directly from the name list of the provider. Or, the information entity makes the request to delete private data to the center, and makes the center delete the private data from a name list of the center. At this time, the deletion is made from the name list of the center, and a similar deletion is made from a name list possessed by a provider to which the name list is provided from the center.

4) The above described three means are applied to the center and a provider to which the center provides private data, and a client computer is installed in the information entity, so that the safe distribution of private data can be made. At this time, this distribution form can be also made available on a commercial basis as business, for example, by setting the price of a license. Note that the center provides private data to providers in units of name lists.

1. outline

1.1 raising of problems

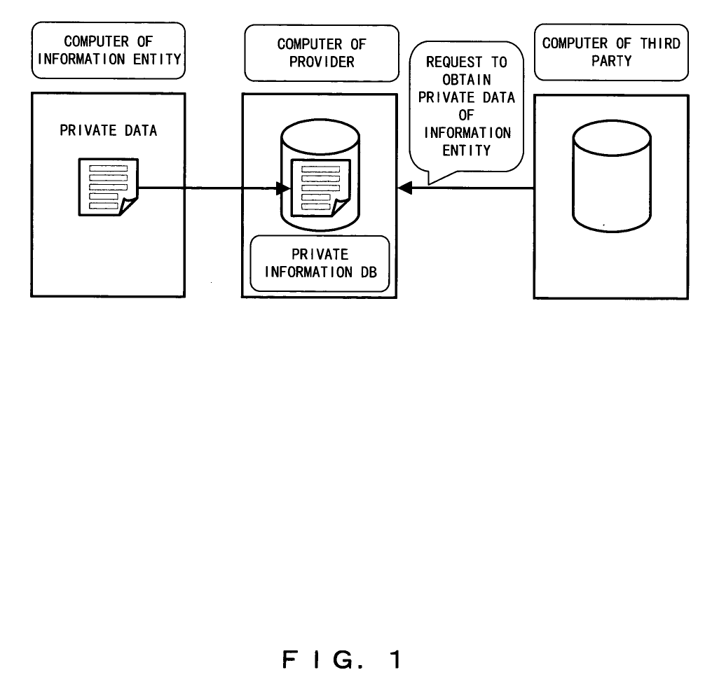

FIG. 1 explains the relationship among an information entity, a provider, and a third party.

Configuration composed of the information entity, the provider, and the third party is considered. The information entity, the provider, and the third party respectively have computers interconnected by a network. The provider holds private data of the information entity in a private information database of its computer. The third party makes a request to obtain the private data of the information entity.

First of all, the following prerequisites must be satisfied between the information entity and the provider.

[Prerequisites of the Provider to the Information Entity]

(1) The provider must notify the information entity of the use purpose of private data, and must use the private data within the scope of the purpose (prohibition of use outside the purpose/illegal use).

(2) The provider must not illegally provide the private data (prohibition of illegal provision/secondary use).

(3) The provider must safely store the private data (safe storage).

(4) The provider must safely collect the private data (safe collection).

(5) The provider must disclose, correct, or delete the private data of the information entity for the information entity if a request is made from the information entity (securing of a control right of the information entity).

After these five prerequisites are satisfied, the provider provides private data to a third party. Also at this time, the third party must satisfy prerequisites to the provider, which are similar to the above described ones. That is,

[Prerequisites of the Third Party to the Provider]

(6) The third party must notify the information entity of the use purpose of the private data, and must use the private data within the scope of the purpose (prohibition of use outside the purpose/illegal use).

(7) The third party must not illegally provide the private data (prohibition of illegal provision/secondary use).

(8) The third party must safely store the private data (safe storage).

(9) The third party must safely collect the private data (safe collection).

(10) The third party must disclose, correct, or delete the private data of the information entity for the information entity if a request is made from the information entity (securing of a control right of the information entity).

A preferred embodiment according to the present invention proposes an implementation method that satisfies these 10 prerequisites.

1.2 outline of a solution

1. A solution to the problems described in the section 1.1 is implemented as follows.

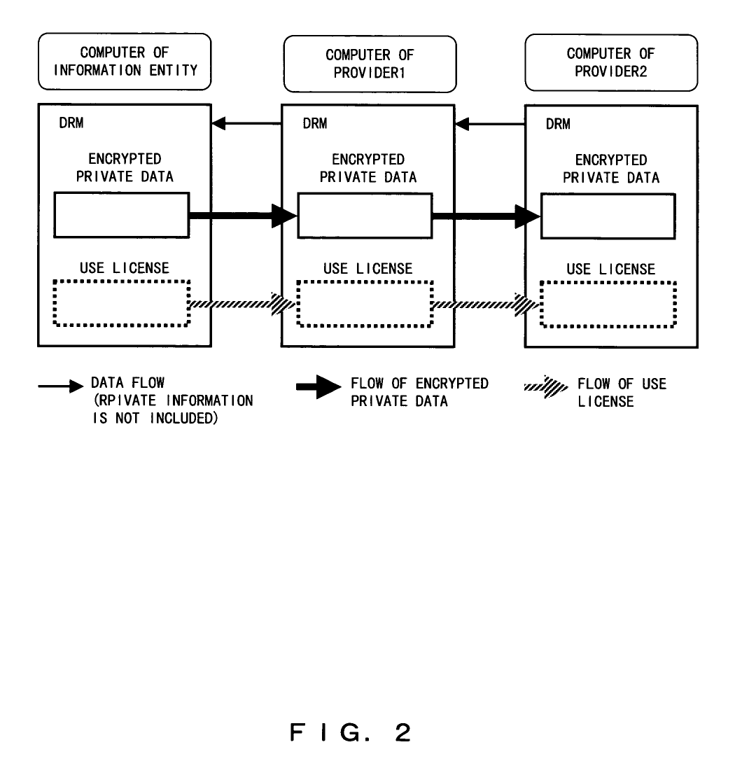

FIG. 2 explains a rough configuration of the preferred embodiment according to the present invention.

Fundamentally, a DRM technology is used for the use of private data. Namely, private data is encrypted, a use license for the encrypted private data is issued (only an information entity can issue a license), and the private data is made available only to an application having a DRM capability. In this way, an illegal use (secondary use/use outside purpose) of the private data can be first controlled.

Additionally, providers store a use license, and devices used are implemented as a TRM, whereby safe storage of private data can be implemented, and safe collection of private data can be made by making an encrypted communication when a license is transmitted/received.

Then, the providers provide services such as disclosure, correction, and deletion to the information entity, whereby the control right of the information entity is secured.

That is, The information entity

encrypts private data.

issues a use license, which is a use condition of the private data.

transmits the license via an encrypted communication.

The provider/third party

uses an encrypted communication when a license is transmitted/received.

stores a license in a unit which has a DRM authentication capability and is implemented as a TRM.

uses private data with a suitable application having a DRM authentication capability.

responds to a request to disclose/correct/delete private data, which is made by the information entity.

2. protection of private data between the information entity and the provider

If a service provider (not a provider that mainly manages private data, but a provider that aims at using private data) makes a request to provide private information to the information entity, the following communication is generally made.

(1) request to provide private information

The service provider makes a request to provide private information to the information entity.

At this time, the service provider notifies the information entity of information items such as “the name of the service provider”, an “inquiry destination”, a “private information item desired to be provided”, a “use purpose”, etc.

The service provider also notifies information such as the name of a service to be received when the private information is provided.

(2) determination of the provision of private information

The information entity determines whether or not to provide the private information based on the information received from the service provider.

(3) provision of the private information

When providing the private information, the information entity creates its own private data, and provides the created data to the service provider.

(4) use of the private information

The service provider uses the received private information within the scope of the use purpose presented to the information entity.

The above described procedures are normal procedures to provide private information. In the preferred embodiment according to the present invention, however, a control for an illegal use/use outside purpose of private information is implemented remotely by using the following mechanism for the procedures (3) and (4).

2.1 mechanism for the provision and the use of private information

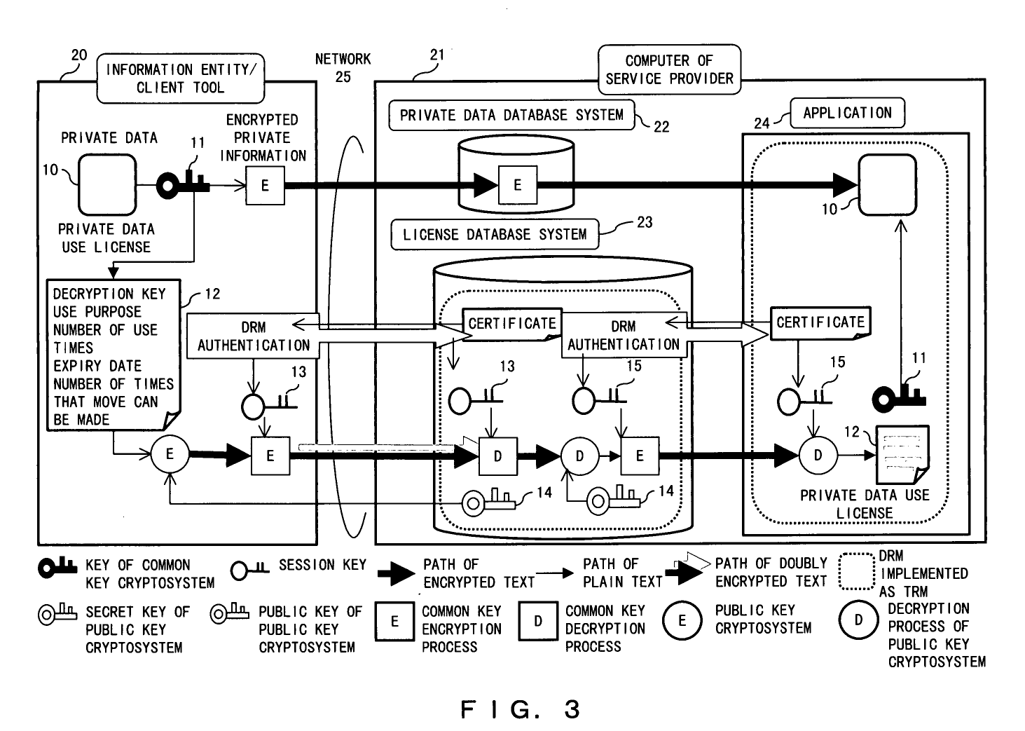

FIG. 3 shows the mechanism for providing private information when an information entity consents to provide private information, and the mechanism with which a service provider uses the private information.

Private data 10 is encrypted with a key 11 of a common key cryptosystem, which is generated by a client tool 20 of a computer possessedby the information entity. The encrypted private data is transmitted to a private data database system 22 of a computer 21 of the service provider via a network 25. When an application 24 uses the private data, the data is loaded into the application 10, which then encrypts the data.

A private data use license 12 includes the encryption key 11 of the common key cryptosystem, which is used to encrypt the private data 10, and is transmitted to a license database system 23, which is provided in the computer 21 of the service provider, via the network 25. At this time, the private data use license 12 is doubly encrypted with a public key 14 of a public key cryptosystem of the license database system 23, and a session key 13 used for DRM authentication, and transmitted to the license database system 23.

2.1.1 editing of the private information by the information entity

Explanation is further provided with reference to FIG. 3.

The information entity 20 edits the private data 10, and encrypts the private data 10 with the public key cryptosystem. The encryption is made by generating a key to respective items of private information, such as an address, a telephone number, etc. Then, the information entity 20 creates the private data use license 12. At this time, the private data use license 12 includes the key 11 used when the private information is encrypted. These processes are executed by the client tool 20 of the information entity. Capabilities of the client tool include the following ones.

capability for issuing a use license

capability for encrypting/decrypting the private data 10 with a common key cryptosystem

capability for generating the encryption key 13

capability for passing encrypted private data

capability for transmitting the private data use license 12 (capability that can make DRM authentication)

[Private Data Use License]

The private data use license 12 represents a use condition of private data 10. On a side using the private data 10, the data is used with the application 24 having a mechanism executed under this condition.

The private data use license 12 is composed of a decryption key 11 for decrypting the encrypted private data 10, an identifier of the encrypted private data 10 which is decrypted with the decryption key, and a use condition. Specifically, the use condition includes, for example, the following. However, the number of copy times is not included in the use condition, and a license is not allowed to be copied.

the number of use times

The information entity 20 can restrict the number of times that its own private data 10 is used.

expiry date

The information entity 20 can specify an expiry date. After the expiry date passes, the private data use license 12 is forcibly deleted from the license database system 23 on the side of a user of the private data 10.

The information entity 20 can decide the expiry date of the private data 10 for a party to which the private data 10 is provided.

the number of move times

The number of times that the private data use license 12 moves between devices having a DRM authentication capability is restricted. Each time DRM authentication is made, the value of a counter to count up the number of move times, which is provided in the computer 21 of the service provider, is decremented by 1.

use purpose

At least, the following use purpose attributes are provided.

examination and development

The private data 10 is executed by an application 24 that takes statistics to examine/develop a product.

lending and selling

data mining

Data mining is executed by a tool which performs data mining.

provider to which a license is permitted to be provided

A type of a service to which a license may be provided is described.

service rejected to be provided

A name of a service not desired to be received is described.

the number of print times

The number of times that the private data 10 is permitted to be printed is described.

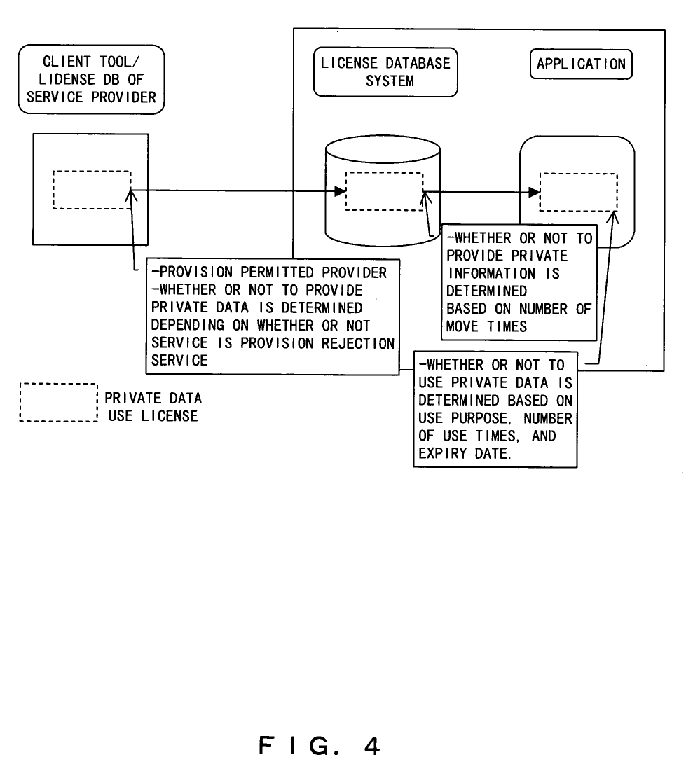

FIG. 4 explains the relationship between the use condition and the use of private data.

The above described use condition is referenced when a private data use license is provided or used as shown in FIG. 4, and a matching is made between a situation where private data is used and the use condition, whereby the provision of a license and the use of private data are restricted.

Namely, when private data is transmitted from a client tool or a first service provider to a second service provider, it is determined (1) whether or not the service provider is a provider to which private data is permitted to be provided, and (2) whether or not the service is a service rejected to be provided, which are the use conditions in the private data use license. Additionally, when private data is moved from a license database system of a computer of the second service provider to an application within the computer of the second service provider, the number of move times of the use condition in the private data use license is referenced, and whether or not to move the private data is determined by examining whether or not the private data can be moved within a specified number of move times. Furthermore, in the application, when the private data is used, whether or not the private data can be used is determined by satisfying the use condition such as (1) use purpose, (2) the number of use times, (3) expiry date, etc. of the private data use license, and whether or not to use the private data is determined.

2.1.2 provision of the private information from the information entity

In FIG. 3, after the information entity 20 encrypts the private data 10 and creates the private data use license 12, it transmits the encrypted private data to the private data database system 22 possessed by the service provider 21, and also transmits the private data use license 12 to the license database system 23. Only an employee who has a particular access right can access the private data database system 22 and the license database system 23 among employees of the service provider 21. All of devices storing the private data use license 12 are assumed to be implemented as a TRM.

To provide the private data use license 12, DRM authentication is used.

On an actual use scene, it is assumed that the service provider 21 makes a request to continuously use the private data use license 12 to the information entity 20 when the expiry date passes and the number of times is used up, and the information entity 20 makes a response to accept/reject the request. Accordingly, when the information entity 20 provides the private data 10 to the service provider 21, the information entity 20 provides to the service provider 21 a private data use license 12 where an appropriate expiry date and number of use times are set in consideration of convenience.

2.1.3 use of the private information by the service provider

The service provider 21 can use the private data 20 only with the application 24 having a DRM capability of a device implemented as a TRM if the use purpose presented when the request to provide private data is made matches a use condition. Namely, in FIG. 3, the encrypted private data 10 is passed from the private data database system 22 to the application 24. At the same time, the private data use license 12 stored in the license database system 23 is encrypted with a secret key 15, and passed to the application 24. The application 24 makes DRM authentication for the encrypted private data use license 12, decrypts the private data use license 12, extracts the decryption key 11 of the private data 10, decrypts the private data 10 with this decryption key 11, and uses the private data 10. This application 24 has a purpose label. If the value of the purpose label does not match a purpose attribute of the private data use license 12, the private data 10 cannot be used. Here, the purpose label possessed by the application 24 is a variable that has a value range of the use purpose attribute of the private data use license 12. This value is assumed to be preset in the application 24 by an application maker, or set with a plug-in.

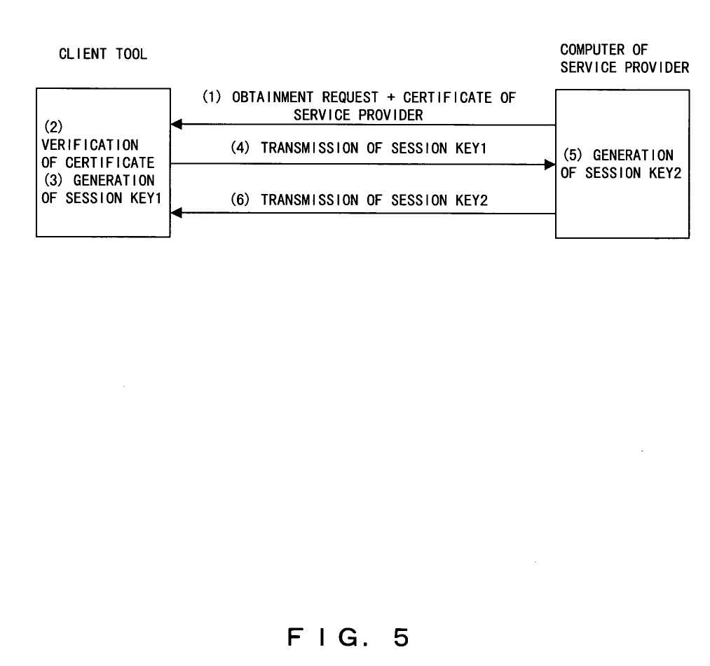

FIG. 5 explains the DRM authentication.

The DRM authentication is a protocol for sharing a session key 2 (secret key) as shown in FIG. 5.

The following explanation on the DRM authentication is provided by assuming that the DRM authentication is made between the computer of the service provider and the client tool of the information entity. Firstly, a request to obtain private data and a certificate of the service provider are transmitted from the computer of the service provider to the client tool ((1)). Next, the client tool verifies the transmitted certificate of the service provider ((2)), and generates a session key 1 ((3)). Then, the client tool transmits the session key 1 to the computer of the service provider ((4)). The computer of the service provider generates a session key 2 ( (5)), encrypts the session key 2 with the session key 1, and transmits the session key 2 to the client tool ((6)).

Here, the session key 1 is encrypted with a public key included in the certificate of the service provider, and transmitted in (4). In (6), the session key 2 is encrypted with the session key 1 by a common key cryptosystem, and transmitted.

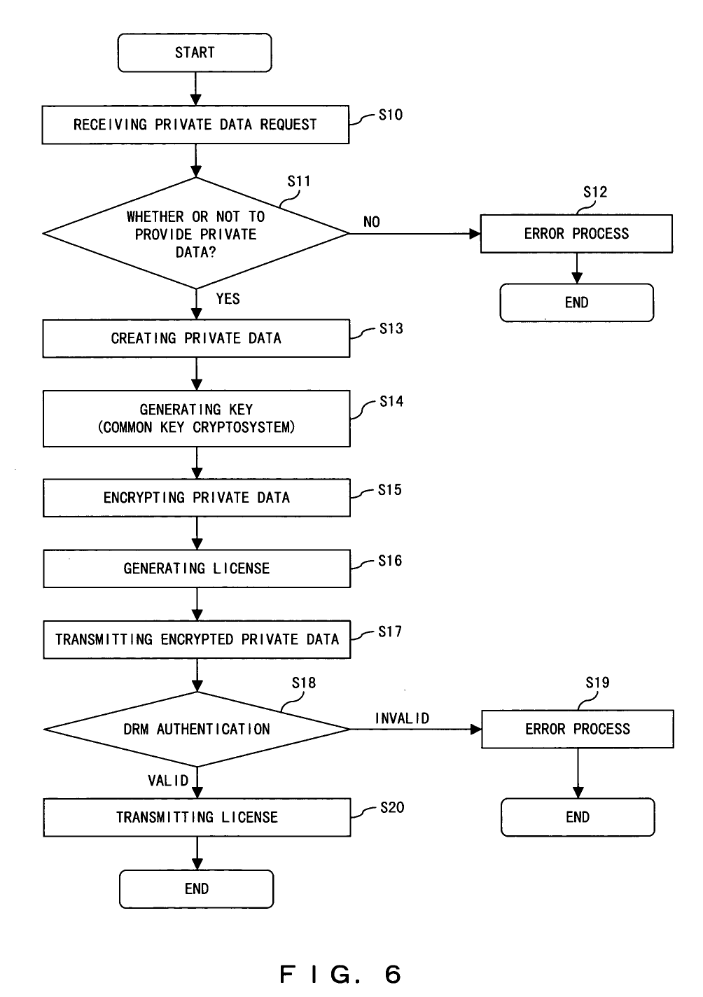

FIG. 6 is a flowchart when a private data use license is transmitted by the client tool.

Firstly, in step S10, a private data request is received. In step S11, it is determined whether or not to provide private data. If the private data is determined not to be provided, an error process is executed in step S12, and the process is terminated. If the private data is determined to be provided in step S11, the process proceeds to step S13 where the private data is created. Then, in step S14, a key of a common key cryptosystem is generated. In step S15, the private data is encrypted. Then, in step S16, a private data use license is generated. In step S17, the encrypted private data is transmitted. In step S18(?), DRM authentication is made for the encrypted private data. If a result of the DRM authentication is invalid, an error process is executed in step S19, and the process is terminated. If the result of the DRM authentication made in step S18 is determined to be valid, the private data use license is transmitted in step S20, and the process is terminated.

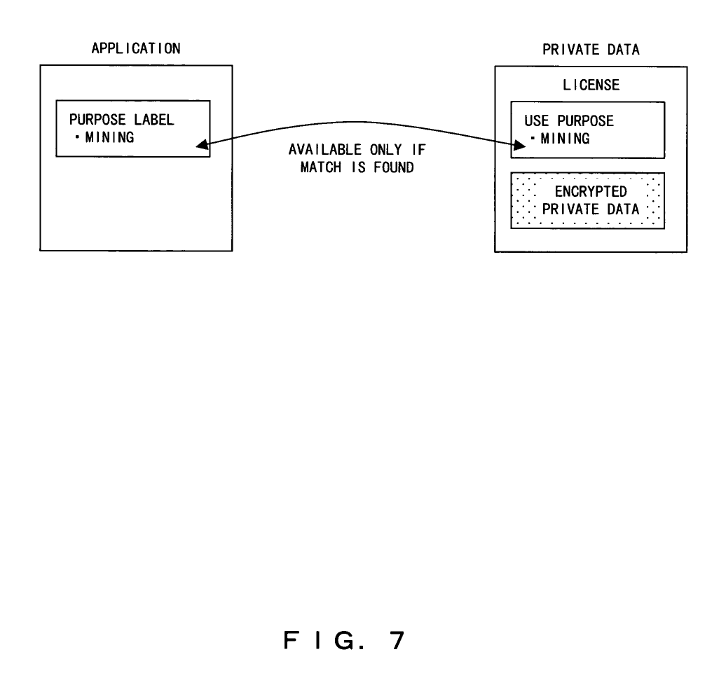

FIG. 7 explains the relationship between private data and a private data use license.

When private data is used, a private data use license is used in addition to encrypted private data. If “data mining” is set as a use purpose of the private data use license, an application on the side of a service provider using the private data cannot use the private data unless “data mining” is set in the purpose label of the application.

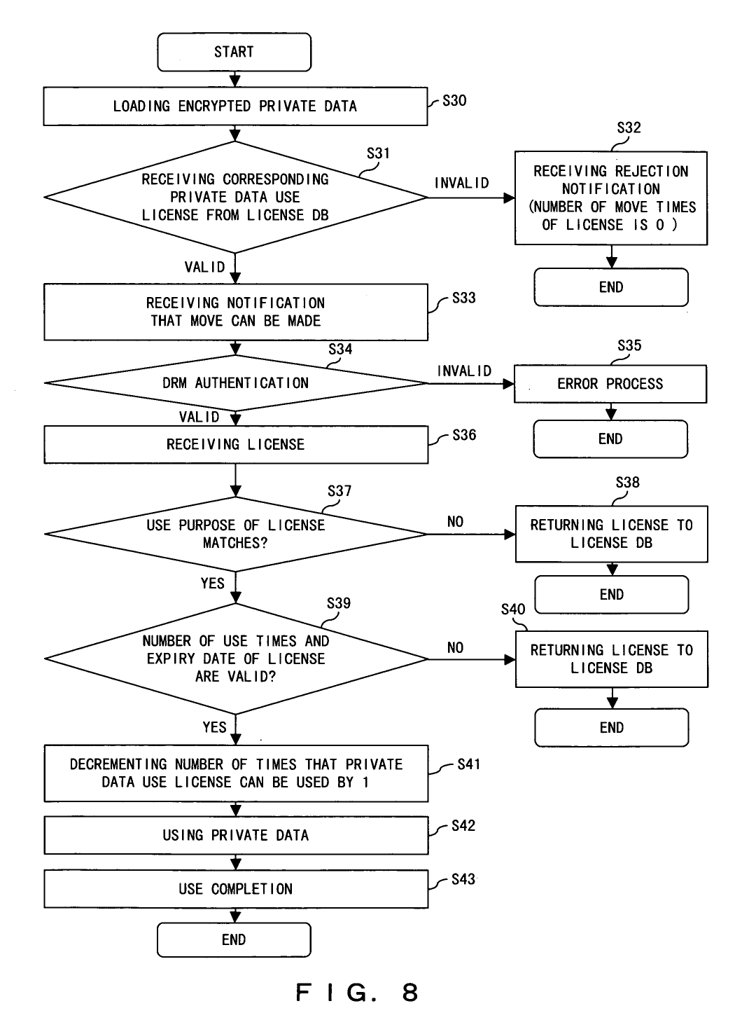

FIG. 8 is a flowchart when private data is used by an application in a computer of a service provider.

Firstly, in step S30, the application loads encrypted private data. In step S31, a corresponding private data use license is received from the license database system, and it is determined whether or not the private data use license is valid. If the private data use license is determined to be invalid in step S31, the application receives a use rejection notification of the private data, and terminates the process. At this time, the number of move times of the license is not incremented.

If the private data use license is determined to be valid in step S31, a notification that the private data use license can be moved is received in step S33. Namely, this move is verified to be a move within an allowed number of move times. Then, in step S34, DRM authentication for the private data use license is made. If a result of this authentication is invalid, an error process is executed in step S35. If the result of the DRM authentication is valid in step S34, the private data use license is received in step S36. Then, in step S37, it is determined whether or not the use purpose of the application and that of the private data use license match. If the use purposes are determined to mismatch in step S37, the private data use license is returned to the license database system in step S38, and the process is terminated.

If the use purposes are determined to match in step S37, it is determined in step S39 whether or not the number of use times and the expiry date of the private data use license are valid. If they are determined to be invalid in step S39, the private data use license is returned to the license database system in step S40, and the process is terminated. If they are determined to be valid in step S39, the private data is decrypted, and the number of times that the private data use license can be used is decremented by 1 in step S41. Then, in step S42, the private data is used. Upon completion of the use of the private data in step S43, the process is terminated.

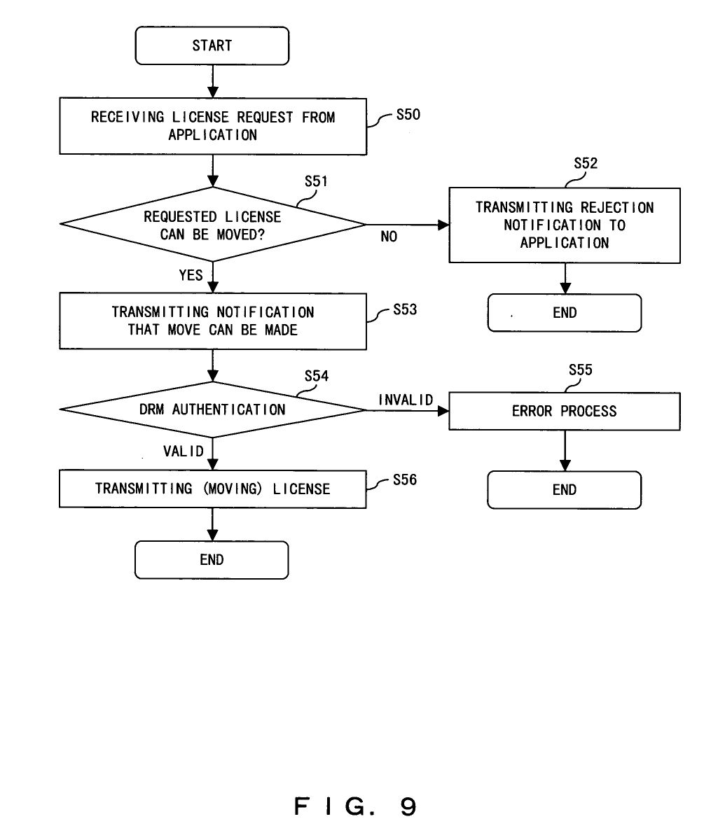

FIG. 9 is a flowchart when a license is transmitted by the license database system.

Firstly, in step S50, a request to obtain a private data use license is received from an application. In step S51, it is determined whether or not the requested private data use license can be moved. If it is determined that the private data use license cannot be moved (“NO”) in step S51, a move rejection notification of the private data use license is made to the application in step S52, and the process is terminated. If it is determined that the private data use license can be moved (“YES”) in step S51, a notification that the private data use license can be moved is transmitted to the application in step S53. Then, in step S54, DRM authentication for the private data use license is made. If a result of the DRM authentication is invalid in step S54, an error process is executed in step S55, and the process is terminated. If the result of the DRM authentication is valid in step S54, the private data use license is transmitted (moved) to the application in step S56, and the process is terminated.

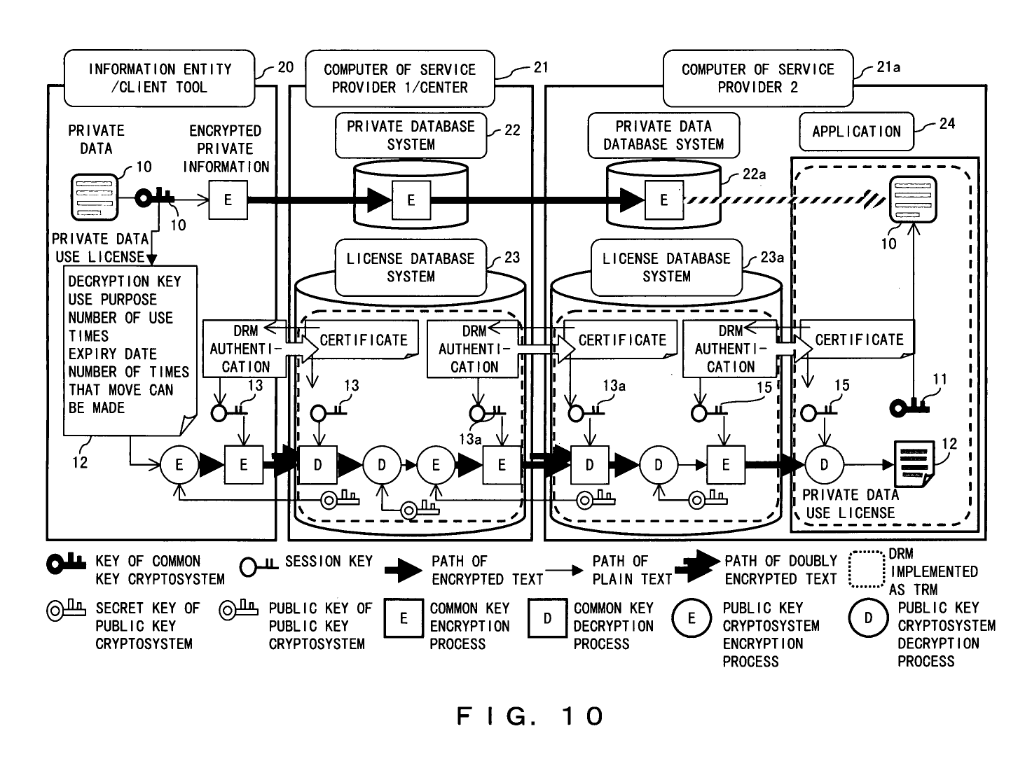

FIG. 10 explains an example where another configuration of a preferred embodiment according to the present invention is applied.

FIG. 10 shows the configuration where a service provider 1 (a computer of a center) receives private data and a private data use license from an information entity 20, stores the data and the license, accepts a request to use the private data from a computer 21a of another service provider 2, and provides the private data to the service provider 2. The same constituent elements as those shown in FIG. 3 are denoted with the same reference numerals.

Upon receipt of the request to obtain the private data from the computer 21a of the service provider 2, the computer 21 of the service provider 1 transmits the encrypted private data to a private data database system 22a in the computer 21a of the service provider 2, encrypts the private data use license with a session key for DRM authentication and an encryption key of a public key cryptosystem, and transmits the encrypted private data use license to a license database system 23a. The use of the private data in the computer 21a of the service provider 2 that receives the encrypted private data and private data use license is similar to that explained with reference to FIG. 3. Its explanation is therefore omitted.

As described above, the preferred embodiment according to the present invention enables the configuration where as the service provider 1, management of private data is mainly made, and the private data is provided along with a private data use license in response to a request to obtain private data, which is made from another service provider. In this case, the service provider 1 serves as a private data management center.

2.2 disclosure request

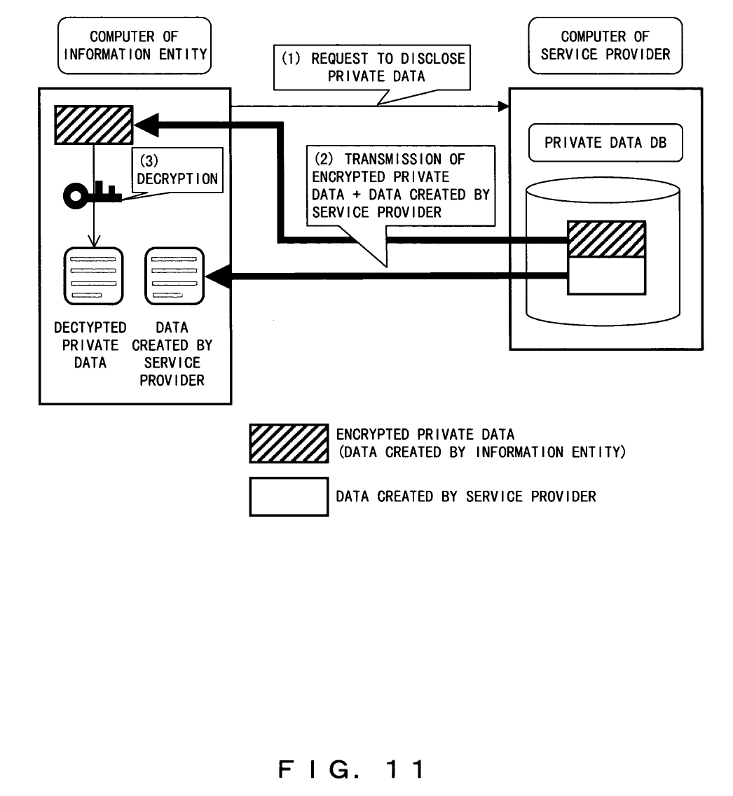

If the disclosure request (request to present private data 10 to the information entity 20) is made from the information entity 20 that provides its private data 10, the service provider 21 that handles the private data 10 must disclose the private data 10 for the information entity 20. FIG. 11 shows the mechanism for the disclosure in the case where the disclosure request is made from the information entity.

(1) request to disclose private data

The information entity makes a request to disclose its own private data to the service provider.

(2) transmission of encrypted private data and data created by the service provider

The service provider transmits to the information entity the encrypted private data from the private data database system, and data which relates to the information entity and is created by the service provider. If the service provider is, for example, a bank, the data created by the service provider is balance information on an account, etc.

The data created by the service provider is sometimes encrypted depending on its contents.

(3) decryption

The information entity decrypts the data with the key used to previously encrypt its own private data, and views the information.

2.3. correction request

If the information entity that provides its own private data makes a request to correct the private data, the service provider that handles the private data must verify if the request is a request made from the information entity itself, and must correct the private data to contents requested by the information entity.

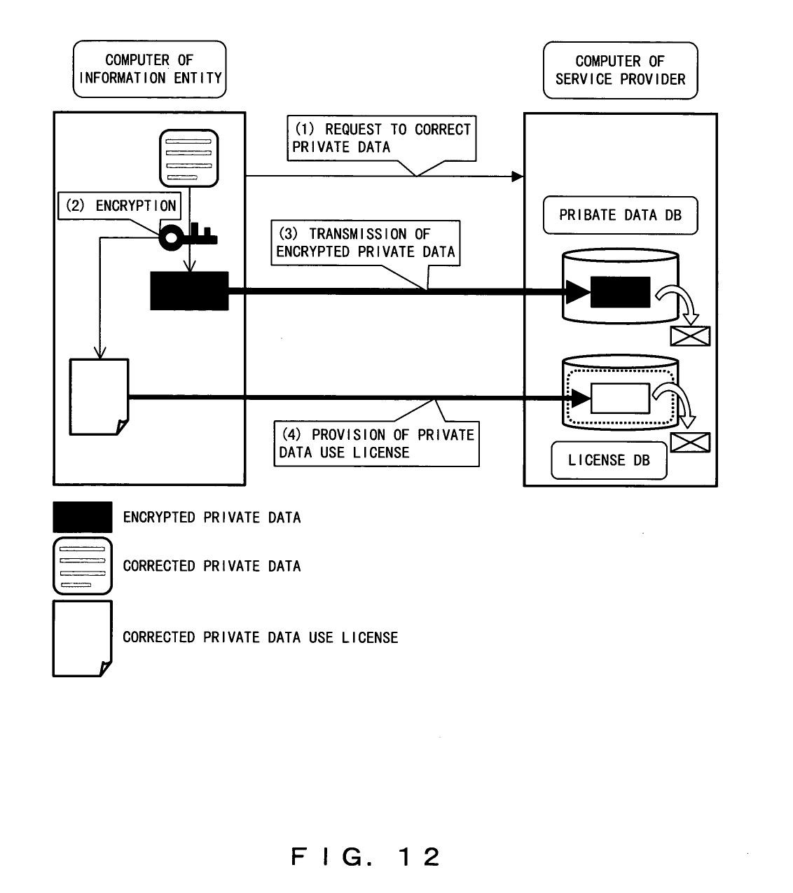

FIG. 12 explains the operations executed when the request to correct private data is made from the information entity.

(1) request to correct private data

The information entity makes a request to correct its own private data to the service provider.

(2) encryption

The information entity prepares own private data corrected, newly generates an encryption key, and encrypts the corrected private data.

(3) transmission of the encrypted private data

The information entity transmits the encrypted private data to the service provider.

The service provider deletes the encrypted private data before being corrected to update to new data.

(4) provision of a private data use license

The information entity provides to the service provider the private data use license where the encryption key information is updated.

The service provider deletes a license before being corrected to update to the new license.

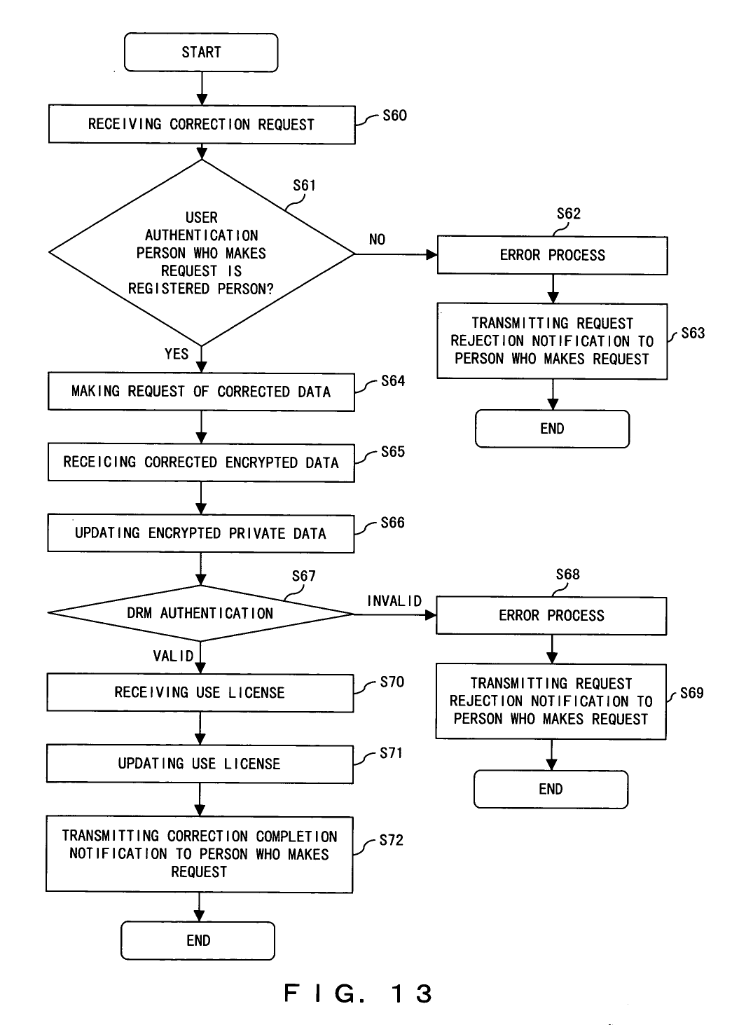

FIG. 13 is a flowchart showing a process for correcting private data, which is executed on the side of the service provider.

Firstly, in step S60, the correction request is received from the information entity. In step S61, user authentication is made to determine whether or not a user that is the information entity and makes the correction request is a registered person. If the user is determined not to be a registered person in step S61, an error process is executed in step S62. Then, in step S63, a request rejection notification is transmitted to the person who makes the correction request, and the process is terminated.

If the user is determined to be a registered person in step S61, a corrected data request is made to the user that is the information entity in step S64. Then, in step S65, the corrected encrypted private data is received. In step S66, the encrypted private data is updated. In step S67, DRM authentication for a private data use license is made. If a result of the DRM authentication is invalid, an error process is executed in step S68, a request rejection notification is transmitted to the person who makes the request in step S69, and the process is terminated. If the result of the DRM authentication is valid in step S67, the private data use license is received in step S70, and updated in step S71. In step S72, a correction completion notification is transmitted to the person who makes the request, and the process is terminated.

2.4 deletion request

Fundamentally, the same procedures as those of the correction request in the section 2.3 are executed. A difference exists in a point that previously used private data and license are deleted and updated by using corrected encrypted private data and a corrected private data use license in the case of the correction request, but this update process is unnecessary in the case of the deletion request. Namely, the encrypted private data and the private data use license, which are possessed by the service provider, are merely deleted.

As a method with which the information entity forces a deletion instruction, the following method can be cited.

[Deletion by a Contract between the Information Entity and a Service Provider that Handles Private Data]

The information entity restricts the use condition of a license, for example, with an expiry date or the number of use times. As a result, a service provider that handles the private data and uses the license makes an inquiry to the information entity so as to update the number of use times, expiry date, etc. At that time, the information entity determines whether or not to permit the continuation of the use. If the information entity does not permit the continuation of the use, the service provider that handles the private data cannot use the private data of the information entity any more. This is virtually the same as the deletion of the private data.

[Deletion by a Proxy License Providing Server]

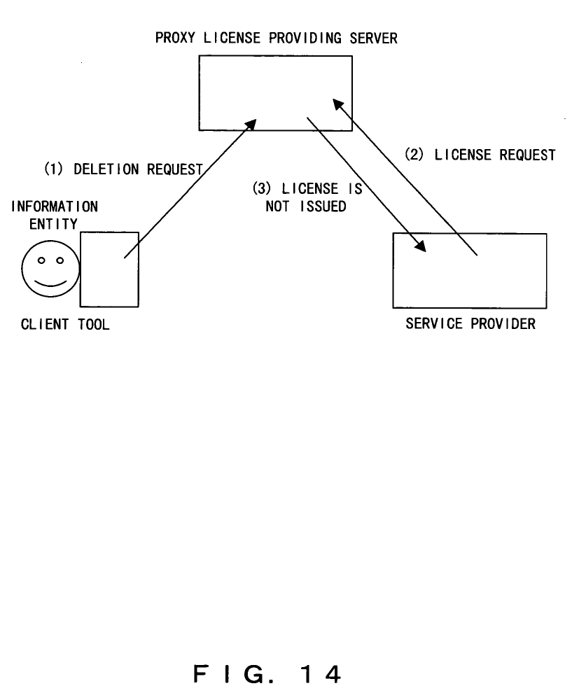

FIG. 14 explains a process for deleting private data, which is executed by a proxy license providing server.

The information entity issues encrypted private data and a private data use license to a trustworthy proxy license providing server. This server provides the private data use license in response to a request of a service provider after winning consent from the information entity. Since this server stays connected, a service provider can access the server to request private data at any time. The service provider makes a license request to the proxy license providing server every day to update the private data use license, if its use condition is restricted, for example, in units of single days. Accordingly, when the information entity makes a deletion request to the service provider, it makes a deletion request to the proxy license providing server, which then implements the deletion request of the information entity by not issuing a license to the service provider thereafter.

Namely, the above described procedures become the following process flow.

(1) The information entity makes a deletion request to the proxy license providing server by using the client tool.

(2) The service provider makes a request to obtain a private data use license to the proxy license providing server in order to use private data.

(3) However, since the proxy license providing server receives the deletion request from the information entity, it does not issue a private data use license to the service provider. As a result, the service provider cannot use the private data of the information entity any more.

2.5 use of private information in units of name lists

Since a service provider holds a large amount of private data, it actually handles private data collected in certain units as a name list rather than using private data individually. Here, a mechanism for using such a name list is explained.

2.5.1 generation of a name list and a name license

A name list is stored in a name list database as a private data name list by concatenating encrypted private data having the same use condition among use conditions included in private data use licenses. Private data use licenses having the same use condition among private data use licenses are collected and organized, each time the private data use licenses stored in the license database are updated. A list of private data use licenses having the same use condition is called a name list license. Based on IDs for identifying the private data included in a name list license, encrypted private data are formed as a private data name list as represented by Table 1.

TABLE 1

| | | | | email | | | | |
|---|---|---|---|---|---|---|---|---|
| | | gen- | birth | ad- | phone | occu- | | inter- |
| ID | name | der | date | dress | number | pation | . . . | est |
| 0001 | *** | male | *** | **@*** | ***-*** | engineer | . . . | sports |
| 0002 | *** | male | *** | **@*** | ***-*** | teatcher | . . . | sci- |
| | | | | | | | | ence |
| . . . | . . . | . . . | . . . | . . . | . . . | . . . | . . . | . . . |
| 1111 | *** | fe- | *** | **@*** | ***-*** | student | . . . | travel |
| | | male | | | | | | |

Here, items other than an ID of the private data name list are encrypted.

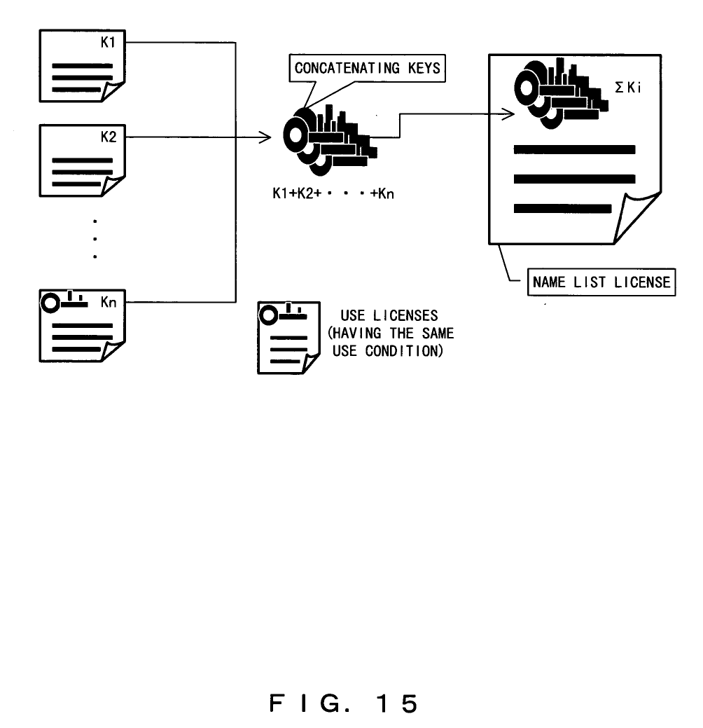

Additionally, a name list license is generated as shown in FIG. 15.

FIG. 15 explains a process for generating a name list license.

Private data use licenses having the same use condition are formed as a group, and encryption keys included in the licenses are concatenated. The concatenated keys and the use condition are combined to generate a name list license. At this time, a license-name list ID that is an identifier for identifying a name list license itself, from which a name list can be referenced, is assigned.

A generated name list license is stored in a name list license database system. Accordingly, an entity list like Table 2 is stored in the name list license database.

TABLE 2

| license-name list ID | | XXX |
|---|---|---|
| condition | usable number | 100 |
| | usable priod | Mar 31, 2003 |
| | movable number | 100 |
| | use purpose | mining |
| | allowed | makers |
| | provider | |
| | disallowed | direct mail |
| | service | |

| | | |
|---|---|---|
| license ID plus key | X1 | 101000101 |
| | X2 | 1100001111 |
| | . | . |
| | . | . |
| | . | . |
| | X1000 | 010101011 |

| | |
|---|---|
| name license key | 101000101\|\|1100001111\|\| . . . \|\|010101011 |
| (concatenated key) | |

These processes are executed by a name list creation tool. Physically, a license database and a name list license database may exist in the same database system.

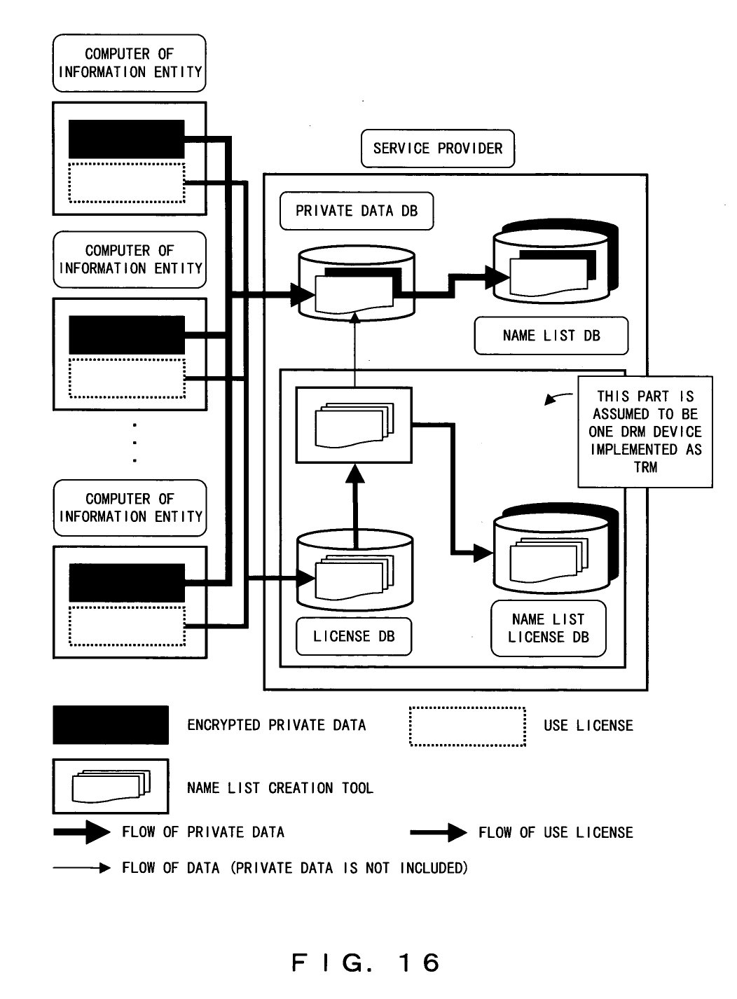

FIG. 16 schematically shows a process for creating a name list and a name list license.

A service provider collects encrypted private data from computers of a plurality of information entities, and stores the collected private data in a private data database. Additionally, the service provider receives private data use licenses from the computers of the respective information entities, and stores the licenses in a license database. The name list creation tool references the license database, searches the private data database for private data having the same use condition, and stores the found private data in a name list database as a name list. Furthermore, the respective private data use licenses are stored in the name list license database as a name list license by the name list creation tool as described above. Here, the name list creation tool, the license database, and the name list license database are devices having a DRM capability implemented as a TRM.

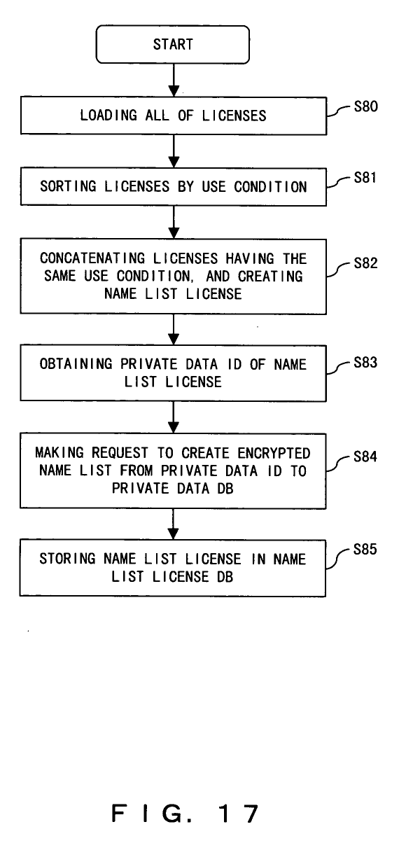

FIG. 17 is a flowchart showing a process for creating a name list/a name list license, which is executed by the name list creation tool.

Firstly, in step S80, all of private data use licenses are loaded. Next, in step S81, the private data use licenses are sorted by use condition. In step S82, private data use licenses having the same use condition are concatenated to create a name list license. In step S83, private data IDs of the name list license are obtained. In step S84, a request to create an encrypted name list from the private data IDs is made to the private data database. Then, in step S85, the name list license is stored in the name list license database, and the process is terminated.

2.5.2 use of a name list

Also a name list is fundamentally used within an application having a DRM authentication capability of a device implemented as a TRM in a similar manner as in the section 2.1.3.

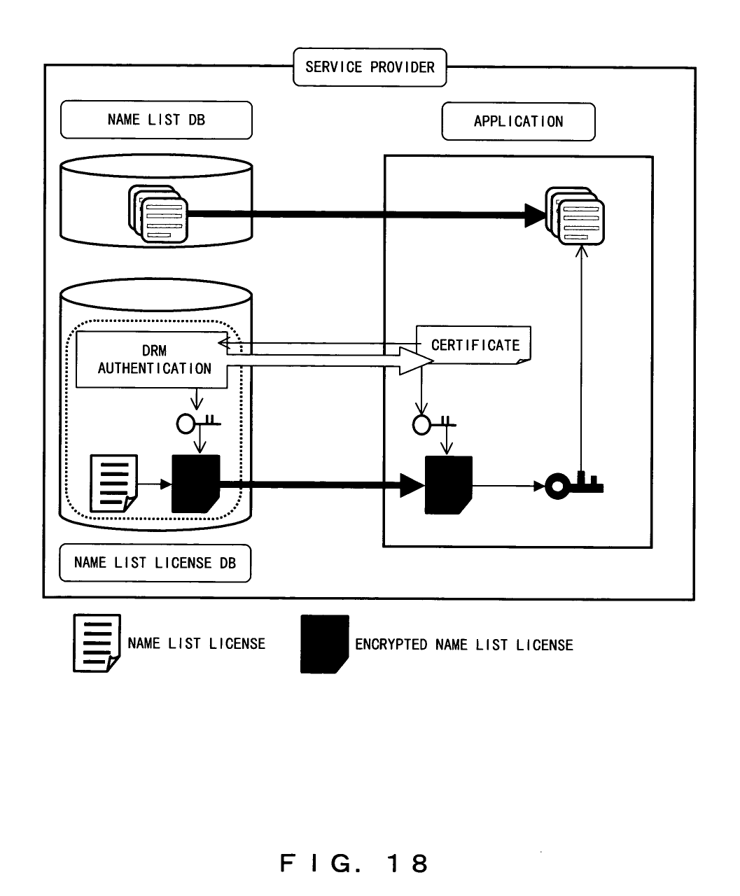

FIG. 18 explains a form where a name list is used.

A service provider loads a name list from a name list database into an application, and at the same time, it passes a name list license stored in a name list license database to the application by using a DRM authentication capability. Then, the application decrypts the name list in accordance with the name list license, and uses the name list.

2.6 disclosure request in the case where a name list is used

When a service provider uses a name list, it transmits both encrypted private data stored in a private data database system and additional information of an information entity in response to the disclosure request made from the information entity. Accordingly, procedures for the disclosure are similar to those described in the section 2.2.

2.7 correction request in the case where a name list is used

To correct private information when a name list is used, a service provider deletes old private data in a private data database system, and receives corrected private data. Thereafter, an item of an information entity in a related name list stored in a name list database system is deleted, and changed to the corrected contents. Also for a private data use license, an old private data use license stored in a license database system is deleted, and changed to a corrected private data use license in a similar manner. Thereafter, a key of the related name list license in the name list license database system is changed. Note that the change in the license is made to a key in an item where private data is changed, and not to a use condition. Accordingly, the change in the name list license is made only to the key.

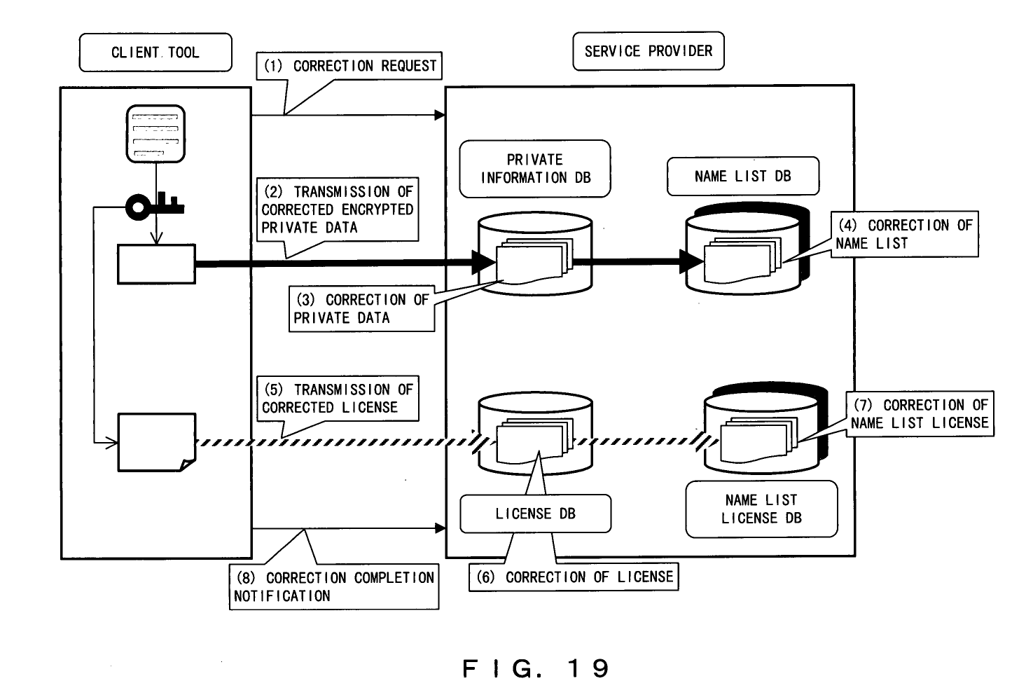

FIG. 19 explains a process of a correction request in the case where a name list is used.

(1) A request to correct private data is transmitted from a client tool to a service provider.

(2) Corrected encrypted private data is transmitted.

(3) Private data is corrected in a private information database of the service provider.

(4) A name list in a name list database is corrected.

(5) A corrected private data use license is transmitted from the client tool to the service provider.

(6) The private data use license is corrected in a license database.

(7) A name list license in a name list license database is corrected.

(8) A correction completion notification is made from the service provider to the client tool.

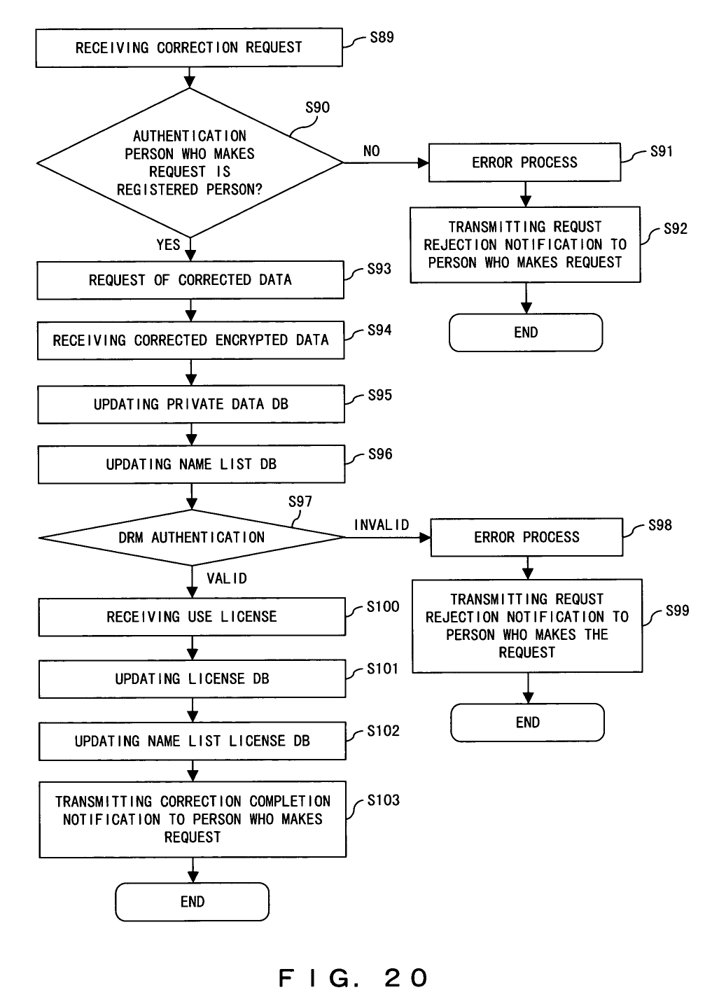

FIG. 20 is a flowchart showing a process for correcting a name list, which is executed by a service provider when a name list is used.

Firstly, in step S89, a correction request is received. In step S90, it is determined whether or not a person that makes the correction request and is an information entity is a registered person. If a result of the determination made in step S90 is “NO”, an error process is executed in step S91, and a request rejection notification is transmitted to the person who makes the request in step S92.

If the result of the determination made in step S90 is “YES”, a request of corrected data is made to the person who makes the request. In step S94, corrected encrypted data is received. In step S95, a private data database is updated. Then, in step S96, a name list database is updated.

In step S97, DRM authentication for transmission/reception of a private data use license is made. If a result of the authentication made in step S97 is invalid, an error process is executed in step S98, and a request rejection notification is transmitted to the person who makes the request in step S99. If the result of the authentication made in step S97 is valid, a private data use license is received from the person who makes the request in step S100, and the license database is updated in step S101. Then, in step S102, a name list license database is updated, and a correction completion notification is transmitted to the person who makes the request in step S103. Here, the process is terminated.

2.8 deletion request when a name list is used

Procedures for deleting private data of an information entity when a name list is used are almost similar to those of the correction request described in the section 2.7. A difference exists in a point that private data is changed to corrected private data in the case of the correction request, but this process is unnecessary in the case of the deletion request.

3. protection of private data between service providers

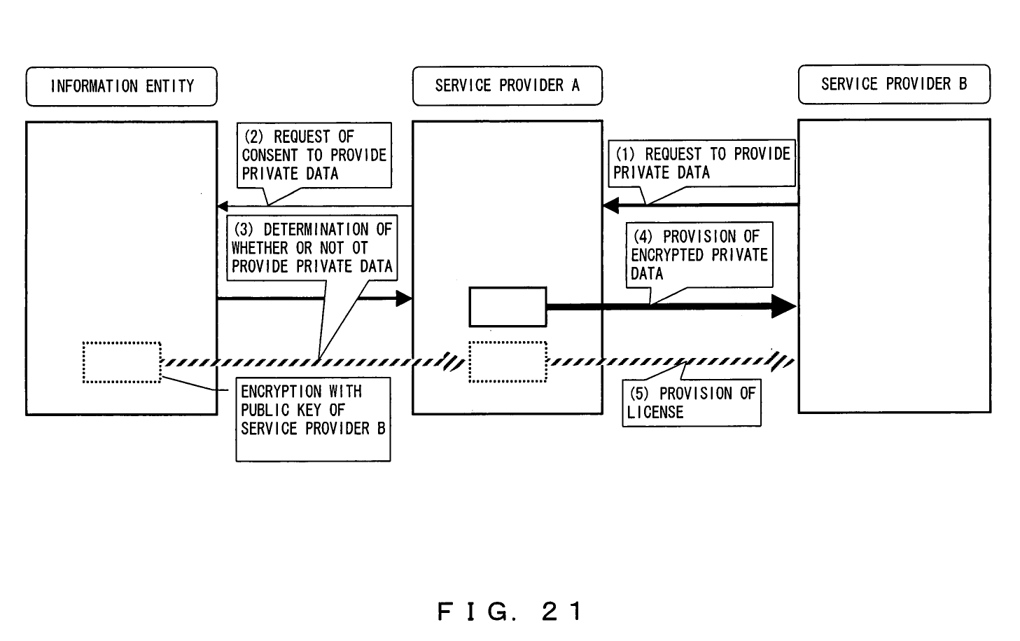

FIG. 21 shows a process for transacting private data between service providers.

When private data is transacted between service providers, it is necessary to win consent to permit the provision of private data from an information entity. A case where a service provider A is assumed to hold private data of a certain information entity, and provides the private data to a service provider B is considered.

3.1 mechanism for providing a license between service providers

(1) request to provide private information

The service provider B makes a request to provide private data to the service provider A.

(2) request to win consent to provide private data

The service provider A notifies the information entity that the request to provide private data is received from the service provider B.

At this time, the service provider A provides at least the following information items of the service provider B to the information entity.

the name and the contact point of the service provider B

the use purpose of the private data

benefits and services which can be received when the private data is provided

an inquiry destination and an inquiry method of a disclosure/correction/deletion request

an electronic certificate that guarantees the identity of the service provider B, such as a certificate of a license database system possessed by the service provider B, or the like

(3) determination of provision

The information entity determines whether or not to provide its private data to the service provider B via the service provider A.

If the information entity determines to provide the private data, it issues a private data use license, and transmits the license to the service provider A. At this time, the private data use license is encrypted with a public key of the license database system possessed by the service provider B.

As a result, the service provider A, via which the private data is provided, cannot use the private data use license.

(4) obtainment of encrypted private data

The service provider A transmits the encrypted private data to the service provider B when a consent notification is received from the information entity.

(5) provision of the license

The service provider B obtains the private data use license from the service provider A.

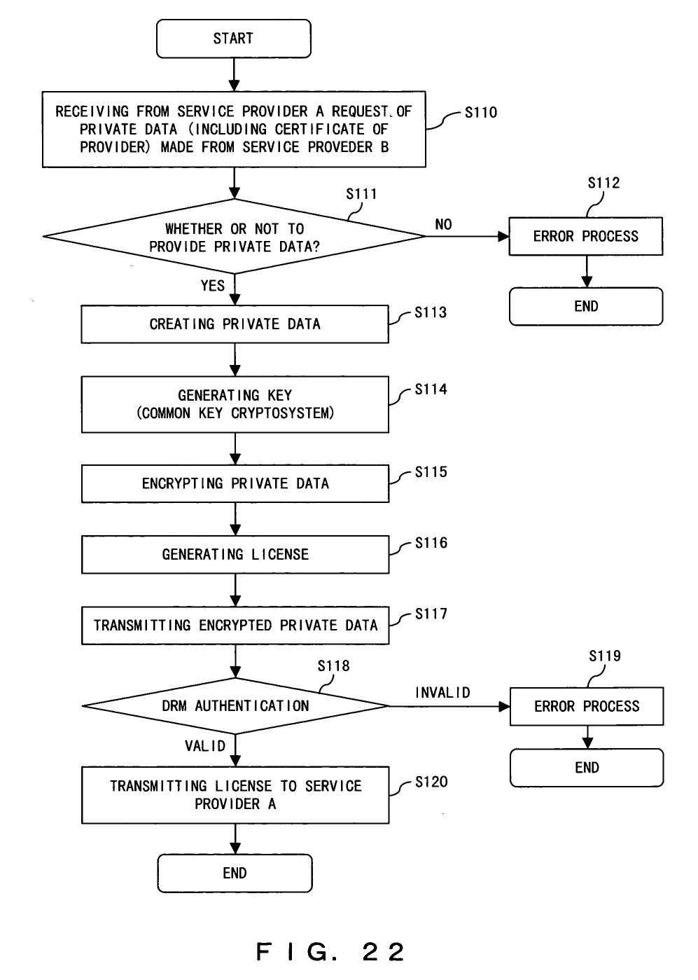

FIG. 22 is a flowchart showing a process executed by the client tool when a private data use license is issued to the service provider B.

In step S110, a private data request (including a certificate of the service provider B) made by the service provider B is received from the service provider A. In step S111, the information entity determines whether or not to provide private data. If a result of the determination made in step S111 is “NO”, an error process is executed in step S112, and the process is terminated.

If the result of the determination made in step S111 is “YES”, private data is created in step S113, and a key of a common key cryptosystem is generated in step S114. Then, in step S115, the private data is encrypted. In step S116, a private data use license is generated. Then, in step S117, the encrypted private data is transmitted. In step S118, DRM authentication is made. For the DRM authentication made in step S118, a public key of the service provider B is used.

If a result of the DRM authentication made in step S118 is invalid, an error process is executed in step S119, and the process is terminated. If the result of the DRM authentication made in step S118 is valid, the private data use license is transmitted to the service provider A in step S120, and the process is terminated. The private data use license that is transmitted to the service provider A is transferred to the service provider B.

3.1.1 disclosure request

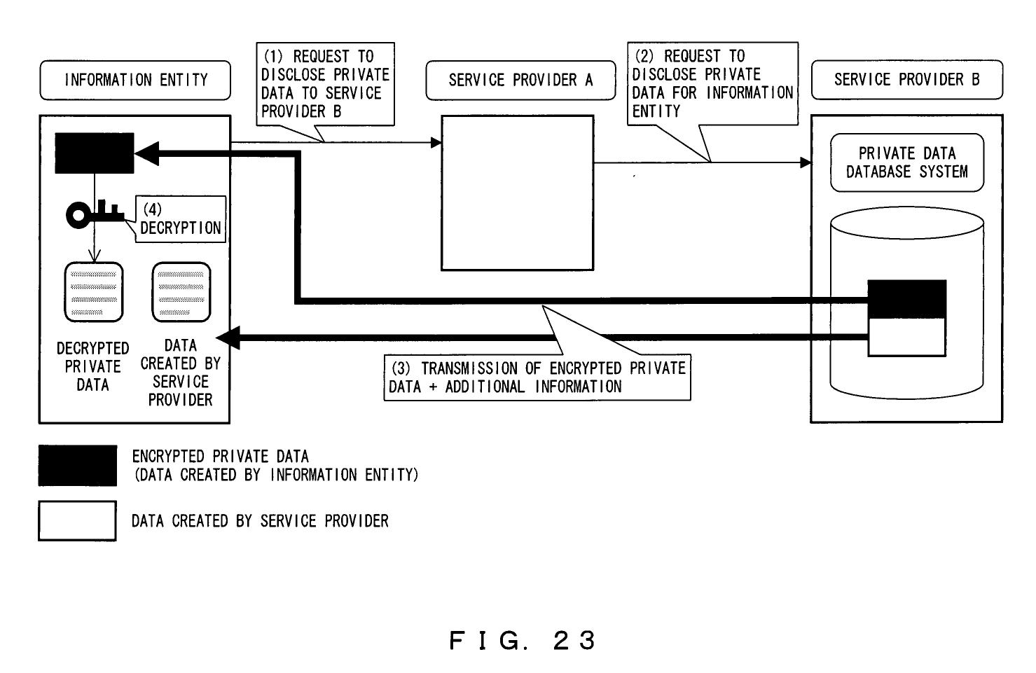

FIG. 23 explains a process of a disclosure request made to the service provider B when private data is transacted between service providers.

When the information entity makes a request to disclose private data to the service provider B, the request is made to the service provider B via the service provider A. Procedures of the disclosure request are the same as those described in the section 2.2 except that the service provider A exists between the information entity and the service provider B.

That is,

(1) The request to disclose private data is made to the service provider B.

(2) The request to disclose the private data for the information entity is made to the service provider B via the service provider A.

(3) The service provider B transmits the encrypted private data and additional information created by the service provider B to the information entity.

(4) The information entity decrypts the received private data.

3.1.2 correction request

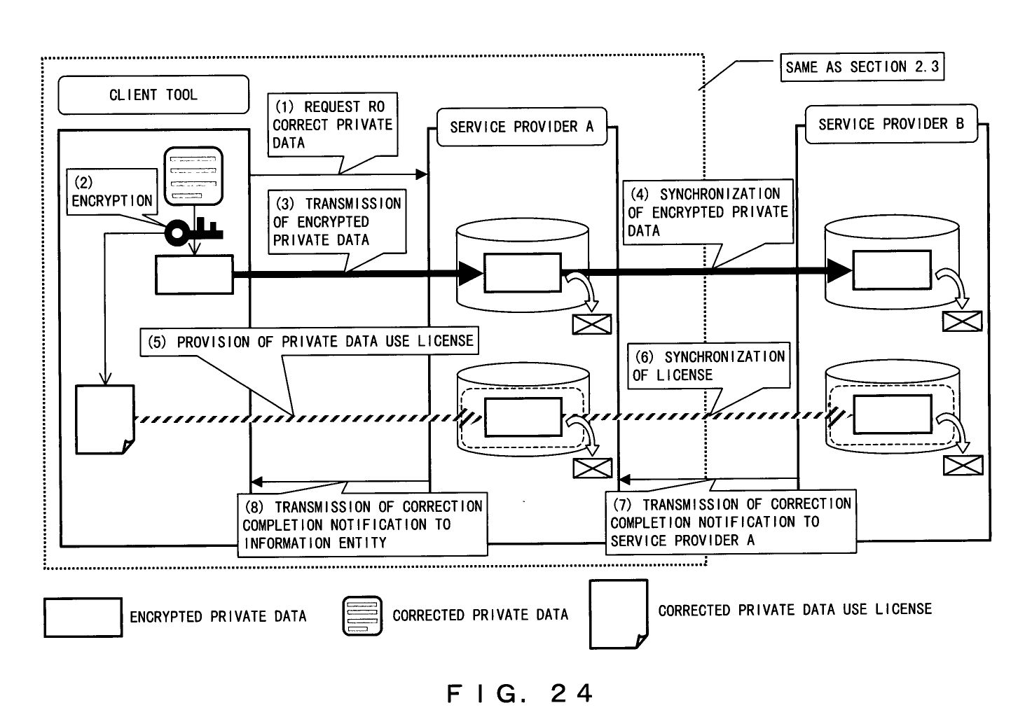

FIG. 24 explains a process of a correction request when private data is transacted between service providers.

If the service provider A provides private data to the service provider B, a process executed in response to a request to correct the private data, which is made from the information entity, becomes the following flow.

The information entity transmits corrected encrypted private data and a corrected use license to the service provider A. The service provider A transmits the corrected information to the service provider B so as to synchronize the corrected private data.

That is,

(1) The client tool transmits the request to correct private data to the service provider A.

(2) The client tool encrypts the private data.

(3) The client tool transmits the encrypted private data to the service provider A.

(4) The service provider A updates old private data with the new private data, and executes a synchronization process for maintaining the sameness of the encrypted private data for the service provider B.

(5) The client tool provides a private data use license to the service provider A. The service provider A updates an old private data use license with the new private data use license.

(6) The service provider A executes a synchronization process for maintaining the sameness of the private data use license for the service provider B.

(7) The service provider B transmits a correction completion notification to the service provider A.

(8) The service provider A transmits the correction completion notification to the information entity.

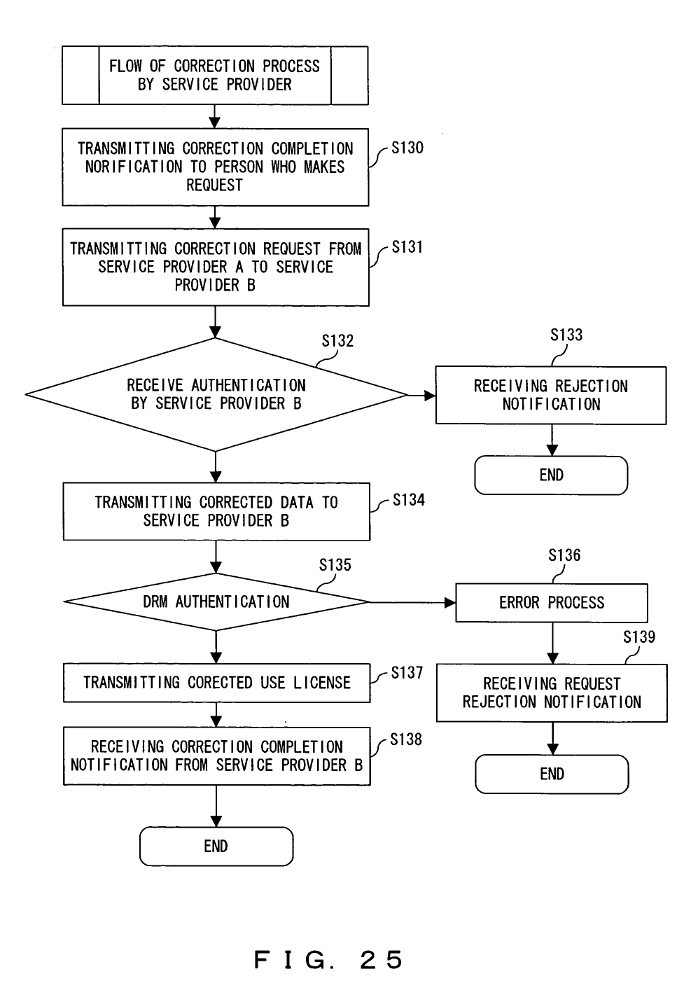

FIG. 25 is a flowchart showing the synchronization process for maintaining the sameness of private data between service providers.

In step S130, a correction completion notification is transmitted to a person who makes a correction request. In step S131, the service provider A transmits the correction request to the service provider B. In step S132, the service provider B makes authentication for the service provider A. If a result of the authentication made in step S132 is determined to be invalid, the service provider A receives a rejection notification in step S133, and the process is terminated. If the result of the authentication made in step S132 is determined to be valid, the service provider A transmits corrected data to the service provider B in step S134. Then, in step S135, the service provider B makes DRM authentication for the corrected data.

If a result of the DRM authentication made in step S135 is determined to be invalid, an error process is executed in step S136, a request rejection notification is received in step S139, and the process is terminated. If the result of the DRM determination made in step S135 is determined to be valid, a corrected private data use license is transmitted in step S137, a correction completion notification from the service provider B is received in step S138, and the process is terminated.

3.1.3 deletion request

Procedures for deleting private data of an information entity when a name list is used are almost similar to those of the correction request described in the section 3.1.2. A difference exists in a point that private data is changed to corrected data in the case of the correction request, but this process is unnecessary in the case of the deletion request.

3.2 in the case where a name list is used

A flow of a process executed in response to the disclosure/correction/deletion request made from an information entity when both of the service providers A and B use private data with a name list.

3.2.1 disclosure request in the case where a name list is used

Procedures are the same as those in the section 3.1.1.

3.2.2 correction request in the case where a name list is used

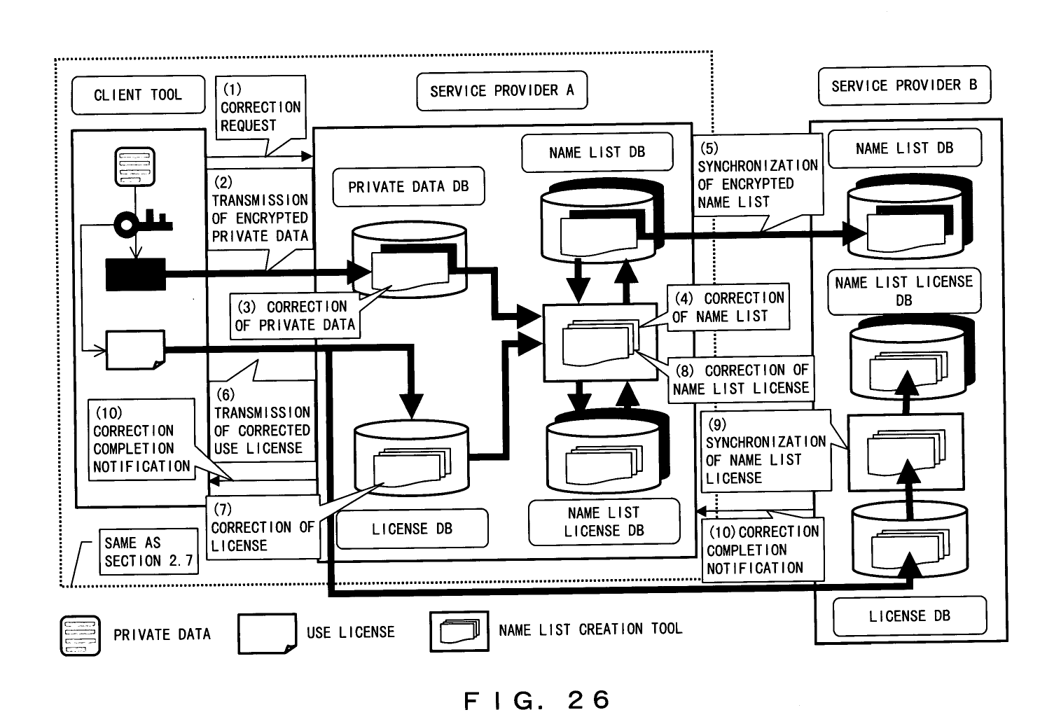

FIG. 26 explains a process of a correction request when a name list is used.

If the service provider A provides a name list to the service provider B, procedures executed in response to the request to correct private information, which is made from an information entity, are almost the same as thoses described in the section 3.1.2.

Namely, if the information entity makes a request to correct private data in a situation where the information entity provides its private data to the particular service providers A and B, it issues two private data use licenses to the service provider A. When issuing the private data use licenses, the information entity transmits to the service provider A a private data license which is encrypted with a public key of the service provider A, and a private data use license which is encrypted with a public key of the service provider B. The service provider A that receives the licenses stores the private data use licenses in the license database, and updates the license database and the name list license database. Furthermore, the service provider A transmits to the service provider B the private data use license for the service provider B. The service provider B that receives the license updates (the license database and?) the name list license database similar to the service provider A.

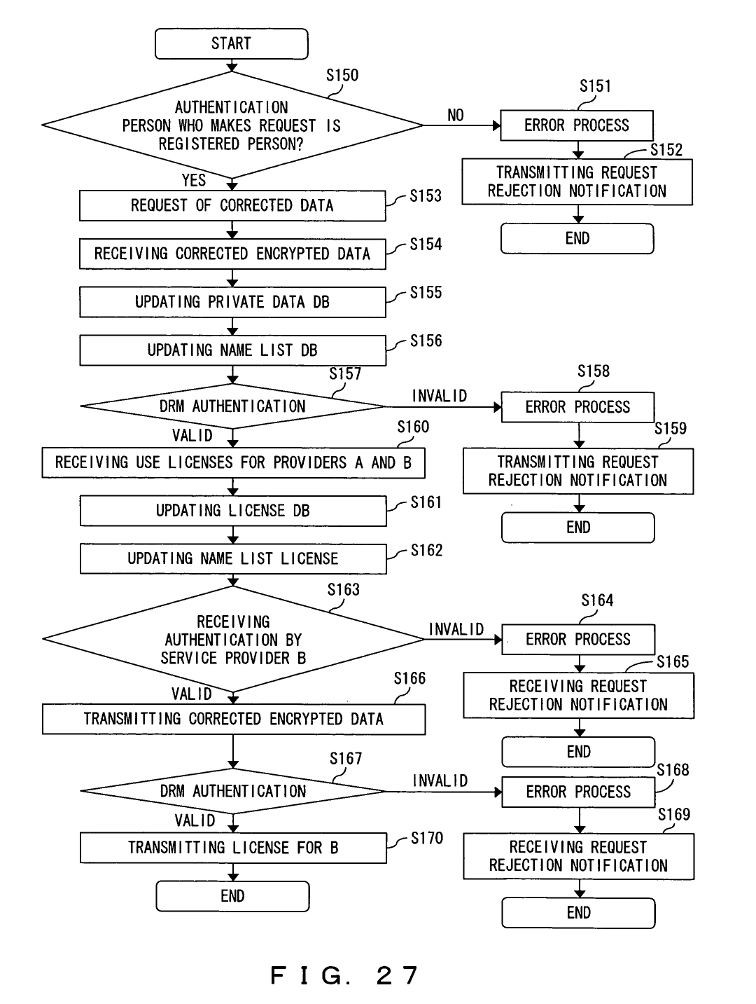

FIG. 27 is a flowchart showing a process of a correction request, which is executed by the service provider A when a name list is used.

In step S150, authentication is made to determine whether or not a person who makes a correction request is a registered person. If it is determined that the person is not a registered person as a result of the authentication made in step S150, an error process is executed in step S151, a request rejection notification is transmitted in step S152, and the process is terminated. If it is determined that the person who makes the request is a registered person as a result of the authentication made instep S150, a request of corrected data is made in step S153. Then, in step S154, corrected encrypted data is received. In step S155, the private data database is updated. In step S156, the name list database is updated.

Then, in step S157, DRM authentication for a private data use license is made. If a result of the authentication is determined to be invalid in step S157, an error process is executed in step S158, a request rejection notification is transmitted in step S159, and the process is terminated.

If the result of the authentication made in step S157 is determined to be valid, the use licenses for the service providers A and B are received in step S160. Then, in step S161, the license database is updated. In step S162, the name list license database is updated. In step S163, the service provider B makes authentication for the service provider A. If a result of the authentication made in step S163 is determined to be invalid, an error process is executed in step S164, a request rejection notification is received in step S165, and the process is terminated.

If the result of the authentication made in step S163 is determined to be valid, corrected encrypted data is transmitted to the service provider B in step S166. In step S167, the service provider B makes DRM authentication. If a result of the DRM authentication made in step S167 is invalid, an error process is executed in step S168, a request rejection notification is received in step S169, and the process is terminated. If the result of the DRM authentication made in step S167 is valid, the private data use license for the service provider B is transmitted in step S170, and the process is terminated.

3.2.3 deletion request in the case where a name list is used

Procedures for deleting private data of an information entity when a name list is used are almost similar to those of the correction request described in the section 3.2.2. A difference exists in a point that private data is changed to corrected data in the case of the correction request, but this process is unnecessary in the case of the deletion request. Namely, private data and a private data use license are only deleted.

4. center type implementation example

Considered is a form where a private data handling provider that solely provides private information serves as a private data center, which manages private data of information entities, and provides private data to a service provider.

Here, it is assumed that a service provider desires the provision of a private data list (name list)

In this implementation example, the center only mediates between the service provider and an information entity. Specifically, when a request to provide private data is made from a certain service provider to the center, the center determines whether or not to provide private data in accordance with a private data use license of the information entity. If the center determines to provide the private data, it notifies the information entity of the provision after the private data is provided.

[How to Provide a License]

The center accepts a request to provide private data from various service providers. If the center wins use consent from an information entity each time it accepts a request, it is inconvenient to an information entity. Furthermore, the center cannot take a quick measure for a service provider.

Therefore, an information entity registers to the center a quantity of licenses such as 100 or 1000, and the center makes a request to update the license registration to the information entity when the registered licenses are used up.

When the center provides a use license to a service provider, it provides a use license by determining whether or not the type of the service provider that makes a request, contents of a service to an information entity, a use purpose, etc. match the attributes of the use license provided by the information entity.

4.1 summary of the center type implementation example

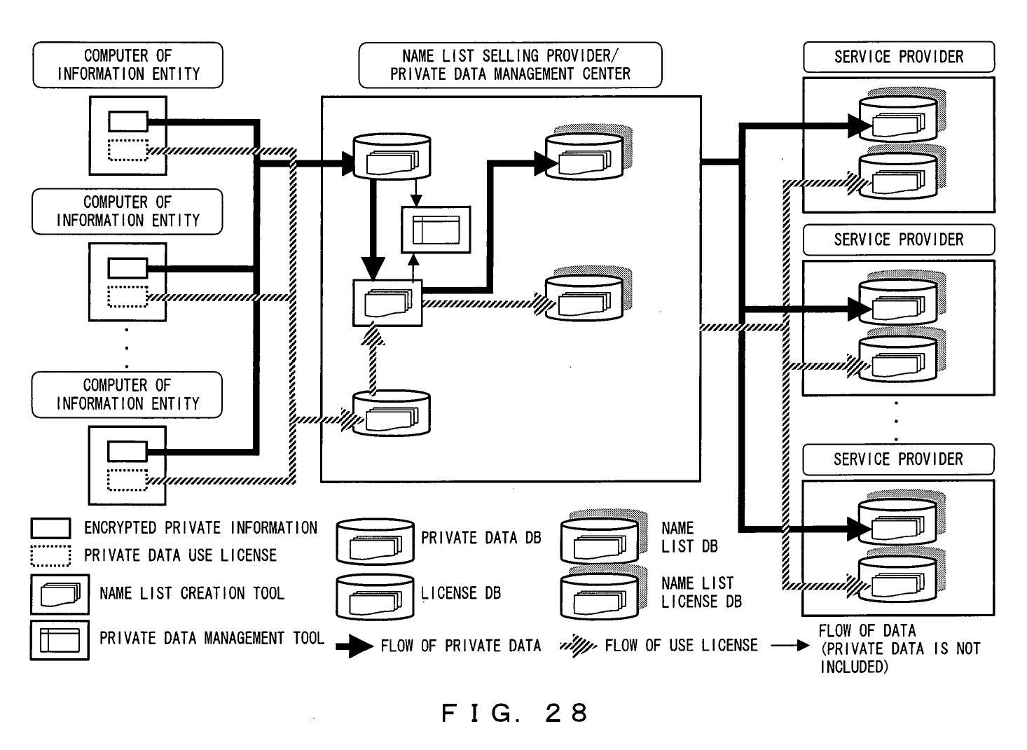

FIG. 28 exemplifies the configuration of a center type private data provision system.

An information entity issues a private data use license by itself. Here, a center mainly manages a provision request made from a service provider, and manages data indicating to which service provider each information entity provides information.

In this form, private information is provided and used according to the following flow. registration flow

1. An information entity makes a registration to the center.

The information entity transmits licenses to the center in certain units.

2. The center issues an ID to a registered person.

The center pairs an ID of a registered person with a contact point (e-mail address), and makes a list of pairs so as to transmit a notification from a service provider. provision flow

1. A service provider makes a request to provide private information (name list) under a certain condition (such as males of twenties, etc.)

At this time, the service provider submits a “condition” and a “provider certificate” to the center.

2. The center searches for information entities that match the condition among registered persons, and identifies information entities that can provide information.

3. A name list composed of private data of matching entities in 2, and a name list license are created.

4. The center provides the encrypted name list and name list use license to the service provider.

5. The service provider uses the received name list within the scope of a use purpose.

6. A notification that the private data is provided to the service provider is made to the matching entities in 4. At that time, at least the following information items of the service provider are provided.

the name and the contact point of the service provider

the use purpose of the private information

benefits, services, etc. which can be received when the private information is provided

an inquiry destination and an inquiry method of a disclosure/correction/deletion request

4.1.1 method searching for a matching information entity

When a request of a name list of private data under a certain condition is made from a service provider to the center, the center searches for private data that satisfies all of the following conditions. This process is executed by using a search tool of a name list license database.

(1) type of a service provider

A comparison is made between a type described in a certificate submitted by the service provider and a provision permitted provider, which is an attribute of a license submitted by an information entity.

For example, in an X.509v3 certificate, the type of the service provider, contents of a service, etc. are described in extended areas.

The X.509v3 certificate is a standard specification of a digital certificate, which is laid down by ITU (International Telecommunications Union). In most cases, digital certificates conform to the format of X.509v3. In v3, extended areas are provided so that a person who issues a certificate can add his or her uniquely determined information.

(2) contents of the service provided by the service provider

A comparison is made between the information of the certificate of the service provider and a provision rejection service, which is an attribute of a license.

(3) use purpose of private data of the service provider

A comparison is made between a use purpose of the service provider and a use purpose, which is an attribute of the license.

(4) condition requested by the service provider (such as a condition where an age is 30 or less, and hobbies include sports, etc.).

An encrypted name list is decrypted, and a comparison is made between the condition submitted by the service provider and the private data.

(1) and (2) are included in the electronic certificate of the service provider in order to verify those information items, so that its legality can be verified.

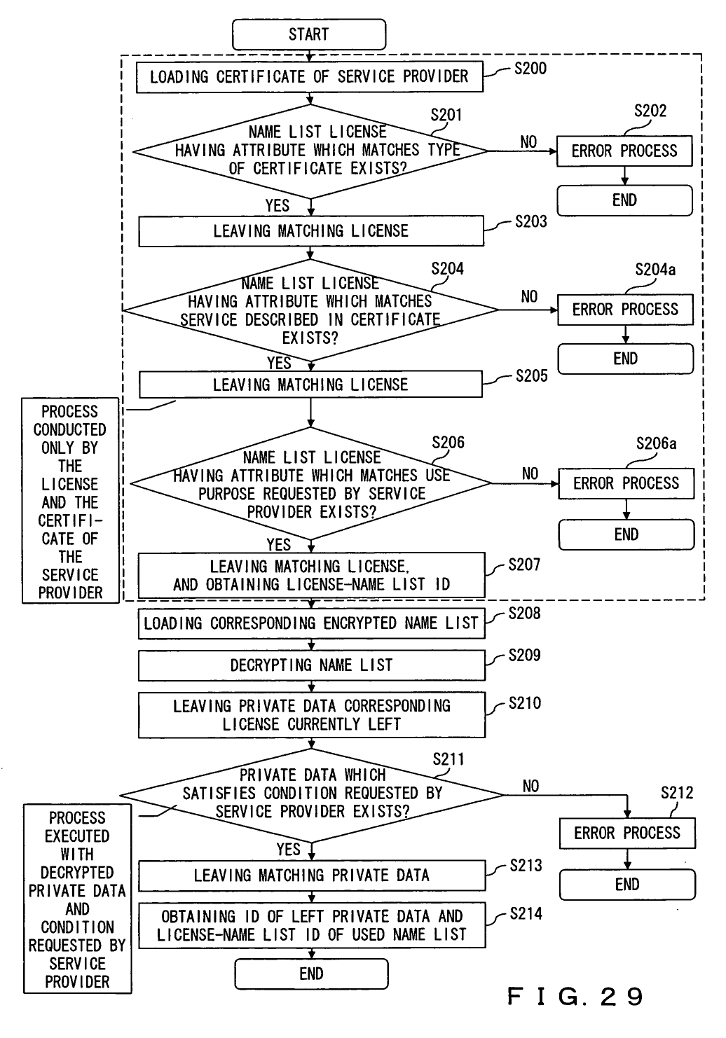

FIG. 29 is a flowchart showing a process executed by the search tool.

In step S200, a certificate of a service provider is loaded. In step S201, it is determined whether or not a name list license having an attribute which matches a type in the certificate exists. If a result of the determination made in step S201 is “NO”, an error process is executed in step S202, and the process is terminated. If the result of the determination made in step S201 is “YES”, a matching license is left in step S203. Then, in step S204, it is determined whether or not a name list license having an attribute which matches the service described in the certificate exists. If a result of the determination made in step S204 is “NO”, an error process is executed in step S204a, and the process is terminated. If the result of the determination made in step S204 is “YES”, a matching license is left in step S205. In step S206, it is determined whether or not a name list license having an attribute which matches the use purpose requested by the service provider exists. If a result of the determination made in step S206 is “NO”, an error process is executed in step S206a, and the process is terminated.

If the result of the determination made in step S206 is “YES”, a matching license is left in step S207, and a license-name list ID is obtained. In step S208, a corresponding encrypted name list is loaded. In step S209, the name list is decrypted. In step S210, private data corresponding to currently left licenses are left. Then, in step S211, it is determined whether or not the private data which satisfies the condition requested by the service provider exists.

If a result of the determination made in step S211 is “NO”, an error process is executed in step S212, and the process is terminated. If the result of the determination made in step S211 is “YES”, matching private data is left in step S213. Then, in step S214, an ID of the left private data, and a license-name list ID of the used name list are obtained, and the process is terminated.

As described above, steps S200 to S207 are a process executed only with the license and the certificate of the service provider. steps S208 to S214 are a process executed with the decrypted private data, and the condition requested by the service provider.

4.2. registration to the center

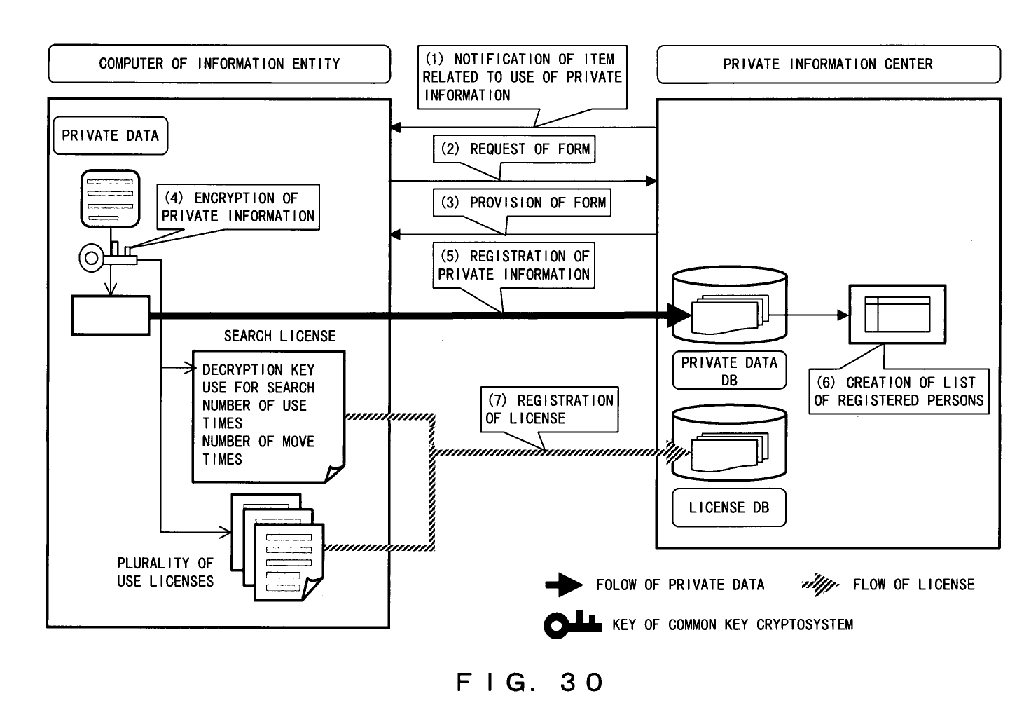

FIG. 30 explains a process for making a registration to the center.

(1) notification of an item on the use of private information

The private information center always presents a stipulation on the use of private information when an information entity registers its own private information.

Contents of the stipulation always include the following items.

(i) Provision to a third party is a use purpose.

(ii) means and method for providing to a third party

(iii) Disclosure/correction/deletion can be made in response to a request of an information entity.

(iv) This service can be stopped in response to a request of the information entity, and information of the information entity is deleted from a list registered to the private information center.

(v) private information items required for registration

A registration form is also included. The information entity enters private information in this form.

(2) request of a form

If the information entity desires to make a registration after considering the above described contents, it makes a request of a registration form to the private information center.

(3) provision of a form

The private information center transmits a registration form upon receipt of the form request.

(4) encryption of private information

The information entity enters private information in the registration form, generates a key of a common key cryptosystem by using the client tool which encrypts the form, and encrypts the form with the key.

(5) registration of private information

The encrypted private information is provided to the private information center.

(6) creation of a list of registered persons

A private data management tool issues an identifier (ID) of a registered person to a person who makes a registration, and creates a list where the ID is paired with an e-mail address.

This list is a list that associates each information entity which makes a registration with information of a service provider to which the information entity provides its private information. See Table 3.

TABLE 3

| | | | resi- | | | |
|---|---|---|---|---|---|---|
| agency | industry | service | dence | contact | item | purpose |
| ***** | maker | — | *** | *** | name/ | market |
| corpo- | | | | | gender/ | search |
| ration | | | | | birth | |
| | | | | | date/ | |
| | | | | | residence/ | |
| | | | | | email | |
| | | | | | address/ | |
| | | | | | interest | |
| *** | IT | — | *** | *** | name/ | market |
| | | | | | gender/ | search |
| | | | | | birth | |
| | | | | | date/ | |
| | | | | | interest | |
| . . . | . . . | . . . | . . . | . . . | . . . | . . . |
| ****** | finance | — | **** | **** | name/ | adver- |
| insur- | | | | | gender/ | tisement |
| ance | | | | | birth | |
| | | | | | date/ | |
| | | | | | residence/ | |
| | | | | | income | |

This list is used to notify a person who makes a registration (information entity) when a request is made from a service provider. This list is also used to verify to which service provider a person who makes a registration provides information, so that the person who makes the registration makes a disclosure/correction/deletion request.

(7) provision of a license

The information entity registers encrypted private information, a search license for searching for private data under a condition requested by a service provider on the side of the center, and use licenses in certain units.

The data management tool in (7) is as follows.

[Private Data Management Tool]

When a private information handling provider provides private data to a third party, the private information handling provider manages a list indicating to which provider private information of an information entity is provided for respective information entities as in Table 3. The private data management tool is a tool for generating a list of providers to which private information is provided for such respective information entities. Furthermore, since this tool never uses private information of information entities, it does not require a DRM capability.

4.3 provision of private data

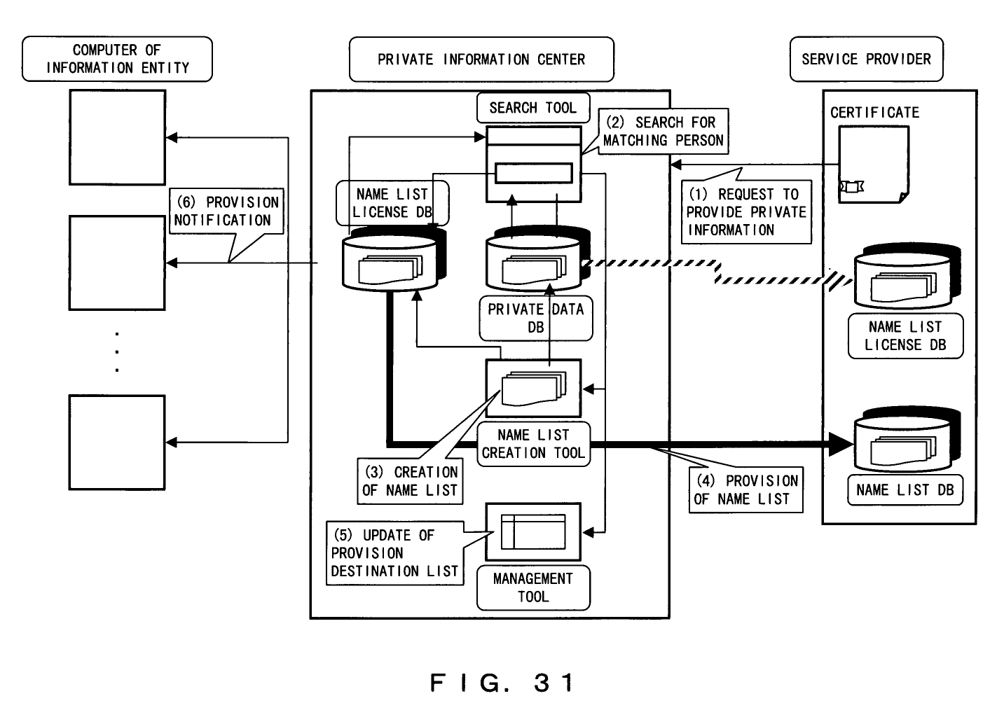

FIG. 31 explains a process for providing private data.

(1) request to provide private information

A service provider makes a request to provide a private information name list to the private information center.

Specifically, the service provider makes a request of a name list under a condition such as males of twenties, or the like.

The service provider submits its certificate (about provider information such as the type of the service provider and contents of a service, etc.).

(2) search for a matching person

The private information center searches for a matching information entity requested by the service provider with the procedures described in the section 1.1.1 by using the search tool.

Encrypted private information, a search license, a condition requested by the service provider, and a certificate of the provider are input to the search tool, and a list of matching IDs is output.

(3) creation of a name list

The private information center creates an encrypted name list composed of the private information of matching information entities in (2), and use licenses of the name list by using a name list creation tool so as to provide private data to the third party, and stores the name list and the use licenses respectively in the name list database system and the name list use license database system.

(4) provision of a name list

The private information center provides the encrypted name list and name list license to the service provider.

(5) update of a provision destination list

The private data management tool updates the provision destination list for the information entities included in the name list created in (3).

(6) provision notification

The private information center notifies each of the information entities that the private information is provided to the service provider.

At this time, the center notifies at least the following information items about the service provider.

the name and the contact point of the service provider

the use purpose of the private information

benefits, services, etc., which can be received when private information is provided

inquiry destination and an inquiry method of a disclosure/correction/deletion request

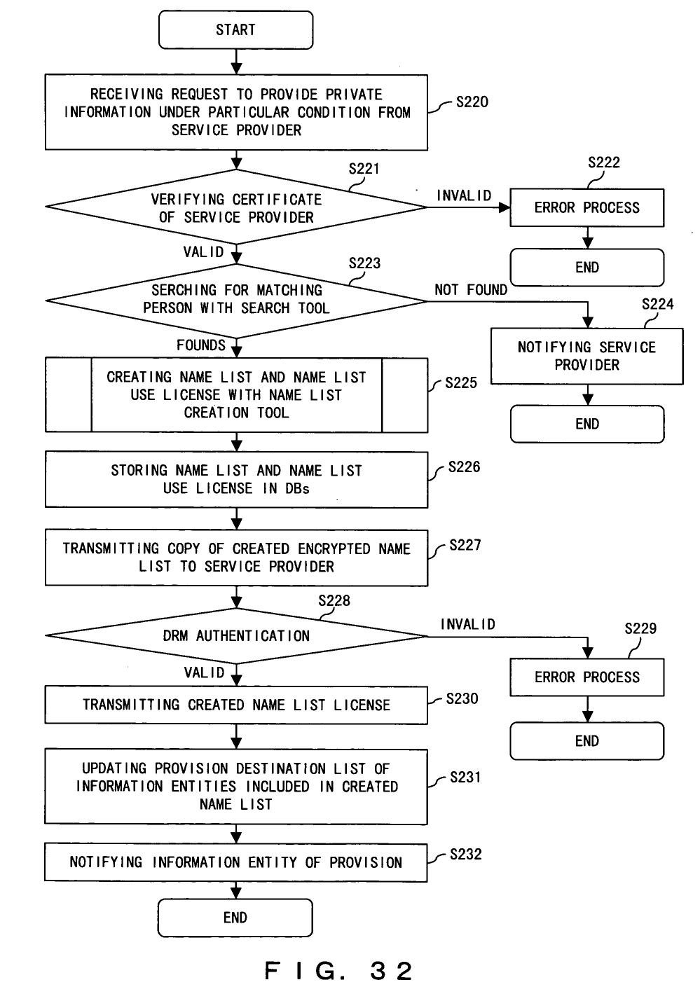

FIG. 32 is a flowchart showing a provision process executed by the center.

In step S220, a request to provide private information under a particular condition is received from a service provider. In step S221, a certificate of the service provider is verified. If the certificate is verified to be invalid in step S221, an error process is executed in step S222, and the process is terminated. If the certificate is verified to be valid in step S221, a matching person is searched with the search tool in step S223. If no matching person is determined to exist in step S223, this is notified to the service provider in step S224, and the process is terminated. If a matching person is determined to exist in step S223, a name list and a name list use license are created with the name list creation tool. Then, in step S226, the name list and the name list use license are respectively stored in the databases. In step S227, a copy of the encrypted created name list is transmitted to the service provider. Then, in step S228, DRM authentication is made. If a result of the DRM authentication made in step S228 is determined to be invalid, an error process is executed in step S229, and the process is terminated. If the result of the DRM authentication made in step S228 is determined to be valid, the created name list license is transmitted in step S230. In step S231, a provision destination list of an information entity, which is included in the created name list, is updated. Then, in step S232, a notification that the information is provided is made to the information entity, and the process is terminated.

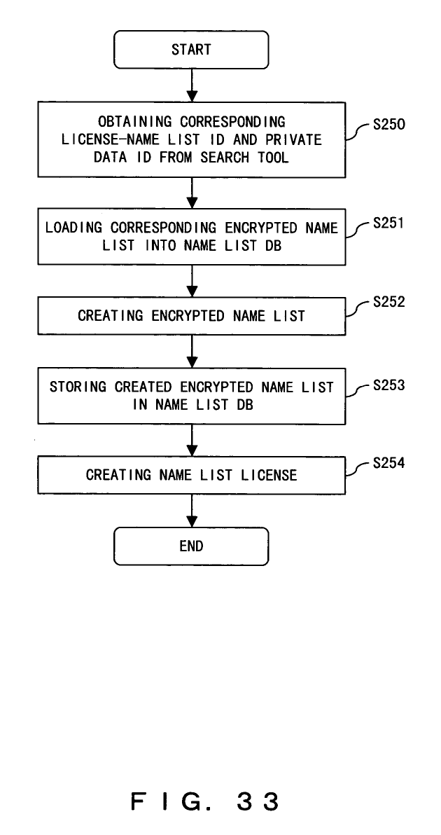

FIG. 33 is a flowchart showing a process executed by the name list creation tool.

In step S250, a corresponding license-name list ID and private data ID are obtained from the search tool. In step S251, a corresponding encrypted name list is loaded into the name list database. In step S252, an encrypted name list is created. Instep S253, the created encrypted name list is stored in the name list database. Then, in step S254, a name list license is created, and the process is terminated.

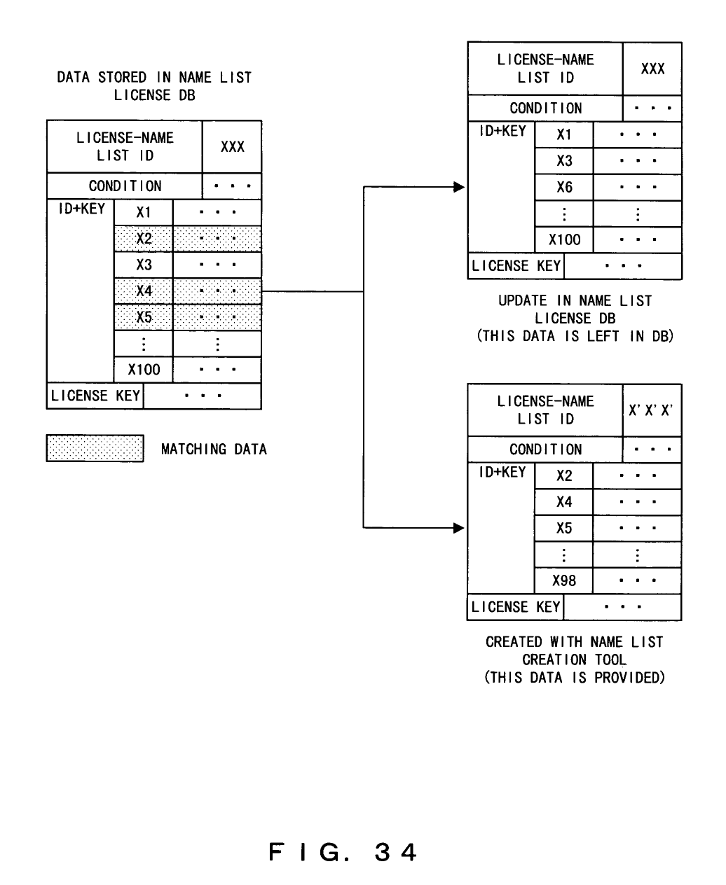

FIG. 34 shows the outline of the creation of a name list license to be provided. Only data which satisfies a predetermined condition is extracted from data stored in the name list license database, and a name list license from which the data is extracted, and a name list created by extracting the data are generated. The name list license created by extracting the data is created by the name list creation tool, and provided to a user.

4.4 disclosure request

Fundamentally, the disclosure request is to transmit encrypted private data and information accompanying the private data to an information entity. Therefore, its procedures are the same as those in the sections 2.2 and 3.1.1.

However, for a center type model, a list created by the private information management tool is provided to an information entity along with encrypted private data.

4.5 correction request

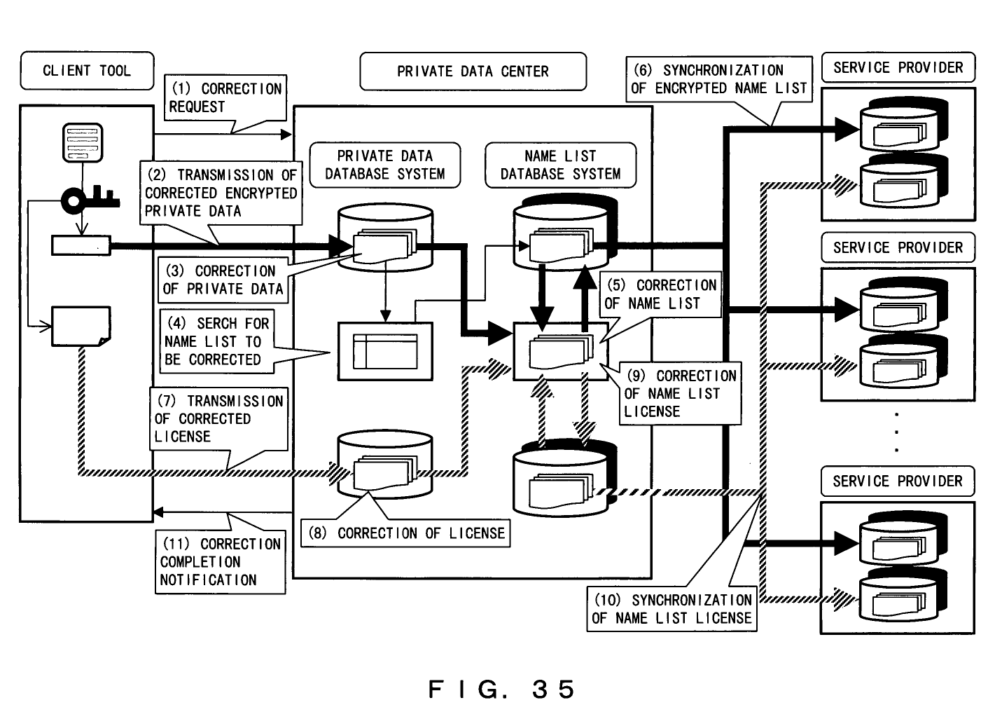

FIG. 35 explains the flow of a process of the correction request.

An information entity passes private data to the private data center and service providers. At all events, a correction is reflected on all of service providers to which the private data is provided if the information entity makes a correction request to the center.

(1) correction request

The information entity makes a request to correct private information to the private information center.

(2) transmission of corrected encrypted private data

The information entity encrypts corrected private data, and transmits the encrypted private data to the private information center. For the encryption of private data, the information entity newly generates an encryption key of a common key cryptosystem for an item to be corrected, and uses the key.

(3) correction of private data

The center deletes old private data of the information entity stored in the private information database, and updates to the new encrypted private data.

(4) search for a name list to be corrected

A name list related to the information entity that makes the correction request is searched with the private data management tool.

(5) correction of a name list

An encrypted name list is recreated by using the name list creation tool, and the updated encrypted name list is stored in the name list database system.

(6) synchronization of encrypted private data

The service provider transmits the corrected encrypted name list so as to synchronize with the name list database systems of the service providers.

(7) transmission of a corrected license

The information entity stores the encryption key used in (2) in the license, creates a new use license, and transmits the license to the center.

(8) correction of the license

The center deletes an old license of the information entity, and updates to the received use license in the license database system.

(9) correction of a name list license

The name list license is recreated with the name list creation tool, and the updated name list license is stored in the name list license database system.

(10) synchronization of the name list license

The service provider transmits the corrected name list license so as to synchronize the corrected name list license with the name license database systems of the service providers.

(11) correction completion notification

The private information center notifies the information entity that the correction is completed.

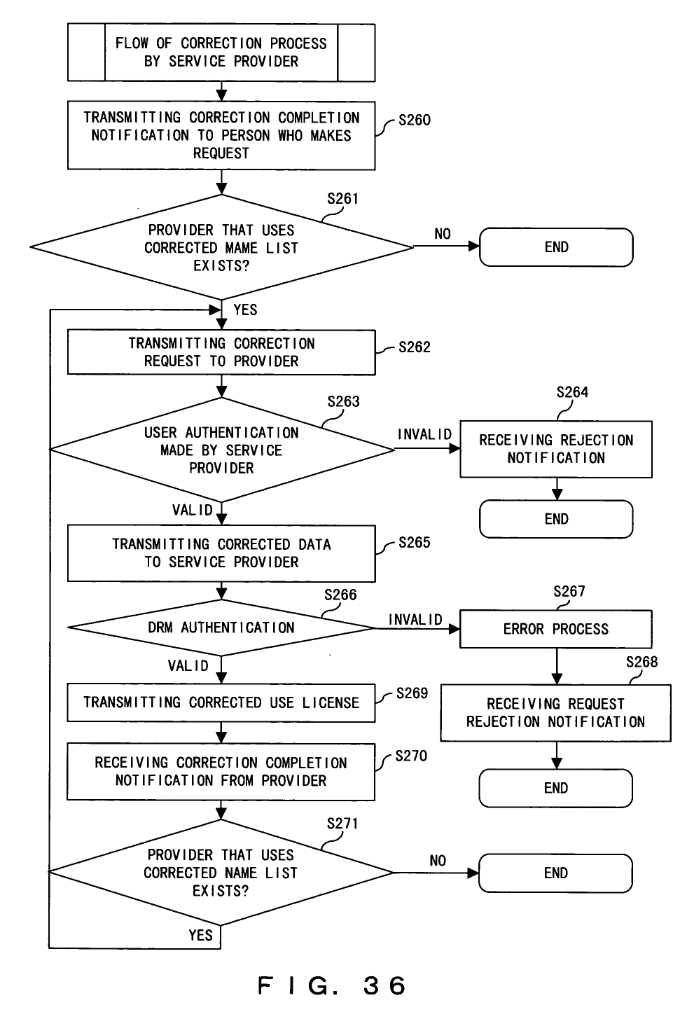

FIG. 36 is a flowchart showing a correction synchronization process which is executed by a service provider when a name list is used.

In step S260, a correction completion notification is transmitted to a person who makes a request. In step S261, it is determined whether or not a provider that uses a corrected name list exists. If no provider is determined to exist in step S261, the process is terminated. If such a provider is determined to exist in step S261, a correction request is transmitted to the provider in step S262. In step S263, the service provider makes user authentication. If a result of the authentication made in step S263 is invalid, a rejection notification is received in step S264, and the process is terminated.

If the result of the authentication made in step S263 is determined to be valid, corrected data is transmitted to the service provider, and DRM authentication is made in step S266. If a result of the DRM authentication made in step S266 is invalid, an error process is executed in step S267, a request rejection notification is received in step S268, and the process is terminated. If the result of the authentication made in step S266 is determined to be valid, a corrected use license is transmitted in step S269. In step S270, a correction completion notification from the provider is received. In step S271, it is determined whether or not a provider that uses the corrected name list exists. If a result of the determination made in step S271 is “NO”, the process is terminated. If the result of the determination made in step S271 is “YES”, the process goes back to step S262.

4.6 deletion request

A deletion request made from an information entity falls into the following two types.

(1) deletion of private data from a name list possessed by a service provider.

(2) deletion of private data from a database possessed by these private information center. This is a stop of a service provided from the center.

4.6.1 deletion of data possessed by a service provider

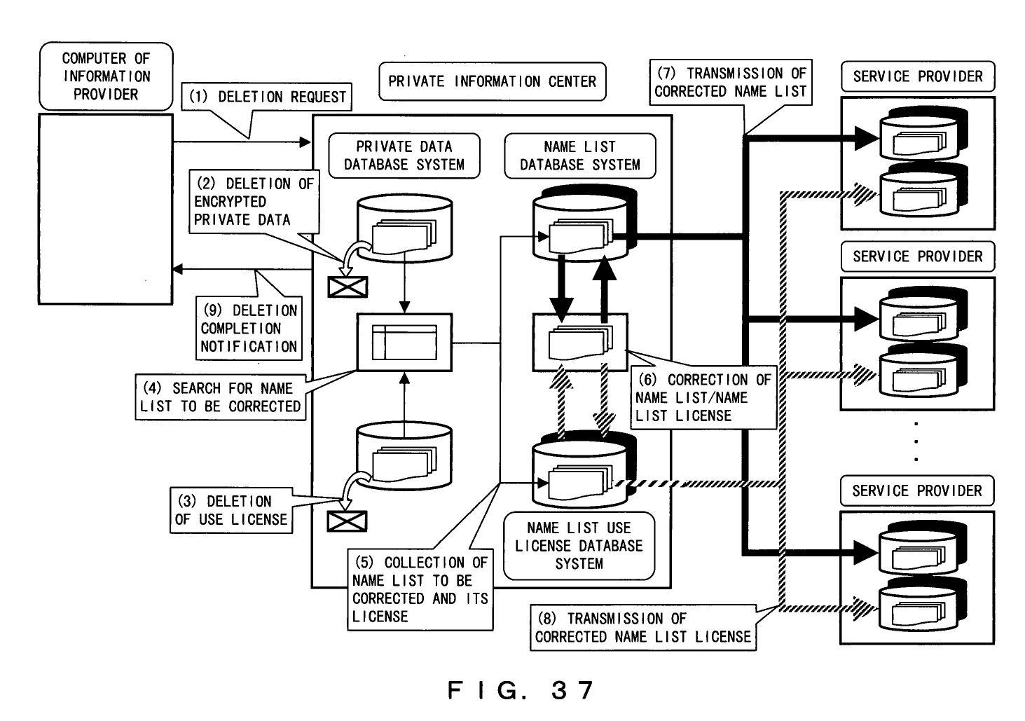

FIG. 37 explains a process for deleting private data possessed by a service provider.

A flow in the case where an information entity stops only a service from a particular service provider is as follows.

(1) deletion request

The information entity makes a request to delete private data to a particular service provider A.

(2) deletion request notification

The private information center notifies the service provider A that the deletion request is made from the information entity.

(3) correction of a name list/name list license

The private information center corrects the name list and the name list license, which are provided to the service provider A, by using the name list creation tool.

Specifically, private data of the information entity that makes the request is deleted from the encrypted name list which is provided to the service provider A, and a use license key of the information entity is deleted from the name list license to update the name list licenses.

(4) transmission of the corrected name list

The service provider A deletes the name list used so far from the name list database, and stores the corrected name list in the name list database.

(5) transmission of the corrected name list license

The service provider A deletes the name list license used so far from the name list license database, and stores the corrected name list license in the name list license database.

(6) deletion completion notification

The private information center notifies the information entity that all of the processes are completed.

4.6.2 deletion of private data possessed by the center

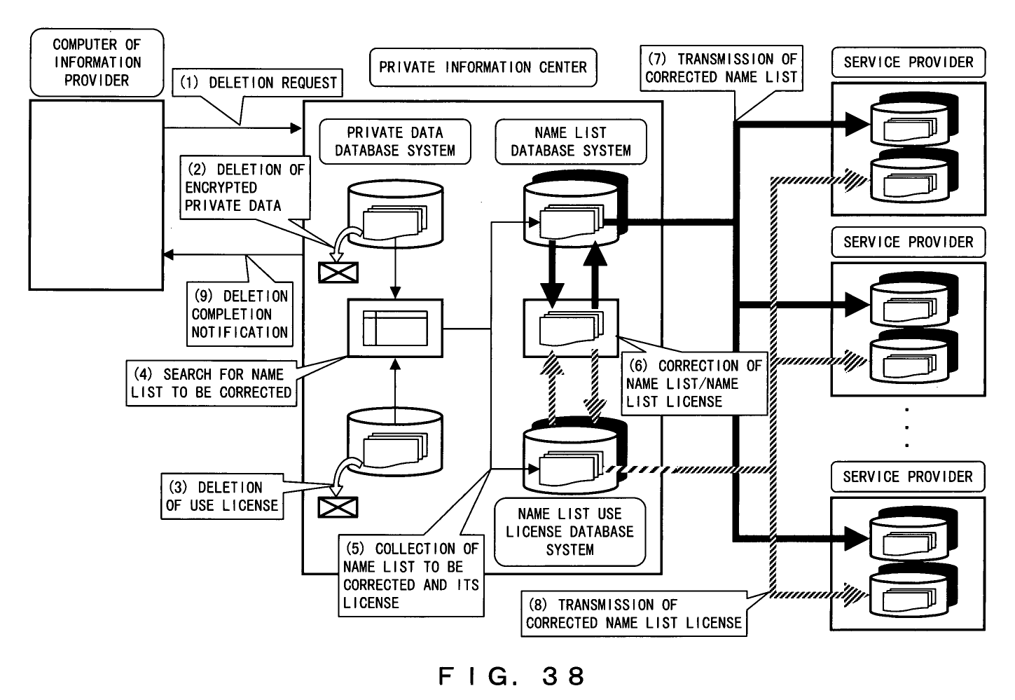

FIG. 38 explains a process for deleting private data possessed by the center.

A flow for stopping a provision request notification service of the private information center is as follows.

(1) deletion request

An information entity makes a request to delete private information (stop of a service from the center) to the center.

(2) deletion of encrypted private data

The private information center deletes encrypted private data of the information entity that makes the request.

(3) deletion of a use license

The private information center deletes the use license of the information entity that makes the request.

(4) search for a name list to be corrected

The private information center searches for a name list related to the information entity that makes the request by using the private data management tool.

(5) collection of a name list to be corrected and its license

(6) correction of the name list/name list license

The private information center corrects the name list and the name list license by using the name list creation tool.

Specifically, the information of the information entity that makes the request is deleted from the name list, and also a key of the information entity, which is included in the name list license, is deleted.

(7) transmission of the corrected name list

The private information center transmits the corrected name list to the service provider, and the service provider deletes an old name list stored in the name list database system, and updates to the corrected name list.

(8) transmission of the corrected name list license

The private information center transmits the corrected name list license to the service provider. The service provider deletes an old name list license stored in the name list license database system, and updates to the corrected name list license.

(9) deletion completion notification

The private information center notifies the information entity that all of the processes are completed.

4.7 one form of center type business

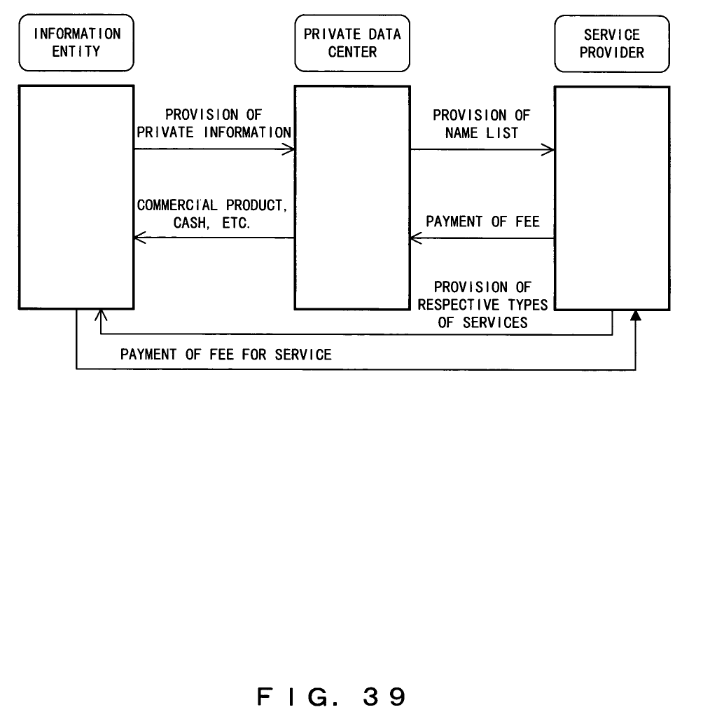

FIG. 39 shows the relationship among an information entity, a center, and a provider in one form of center-type business.

A business form where a private information center takes a leading part, and provides a service to the information entity and the service provider is considered.

4.7.1 relationship between the information entity and the private information center

The information entity provides private information to the center.

The center gives points when the information entity makes a registration.

The center gives points when the private data is provided to the service provider.

The information entity can replace points with a commercial product and cash when the points are accumulated to some extent.

[How to Add Points]

The center adds points for the information entity that makes a registration in the following cases.

In the case where the information entity registers its private data to the private information center.

In the case where private data is provided. The information entity provides encrypted private data and its use license. Since only an information entity can issue a use license, a quantity of licenses such as 100, 1000, or the like are initially provided.

In the case where the center makes a request to issue a license to the information entity when licenses are used up.

In the case where the center provides private data to the service provider.

How to add points is set, for example, as represented by Table 4.

TABLE 4

| | | points (for | charge (for |
|---|---|---|---|
| | | information | agency) |
| | | entity) | |
| usable priod | | 100 points/a year | 1000 yen/half a year |
| movable number | | 10 points/move | 100 yen/move |
| usage purpose | search | 5 points | 50 yen |
| | lental/sale | 10 points | 100 yen |
| | mining | 7 points | 70 yen |
| | . | . | . |
| | . | . | . |
| | . | . | . |

4.7.2 relationship between the center and the service provider

The center provides private data to the service provider.

The service provider pays a use fee of the private data to the center.

When a request to provide a name list is received from the service provider, the private information center provides an encrypted name list and name list use license. At that time, the private information center collects a fee for the use of the name list by the service provider. Actually, however, the encrypted name list is enough to be once stored in the name list database. Therefore, the name list is provided to the service provider only when the service provider makes the initial request to provide a name list to the center. Accordingly, a subsequent name list request from the service provider is made only for a name list license. However, if a correction of the private data is made from the information entity to the center, the center transmits the private data so as to synchronize the private data.

When the private information center provides a license to the service provider, a license use fee is calculated by a license fee calculating device and a charging system. The license value calculating device is a device which converts an issued use license into a numerical value (an amount of money or points) . The charging system is a system which calculates an amount of money to be charged by totaling amount data.

4.7.3 the information entity and the service provider

The service provider provides a service to the information entity.

The information entity pays a service fee to the service provider.

4.7.4. price setting of a license

It is natural that the points/the amount of money of a license may vary depending on its use condition. For example, if a comparison is made between one day and one month, which are expiry date attributes of a use license of the same encrypted private data, the value of the use license for one month is considered to be higher as a matter of course. Such a value standard of a price depending on a use condition of a use license is preset by the private information center, or determined, for example, by means of a negotiation made between the service provider and the center. For instance, points and a fee structure as in Table 4 are determined. However, for sensitive private data, its points/fee structure should vary naturally.

4.7.5 flow of a process in the business form data flow

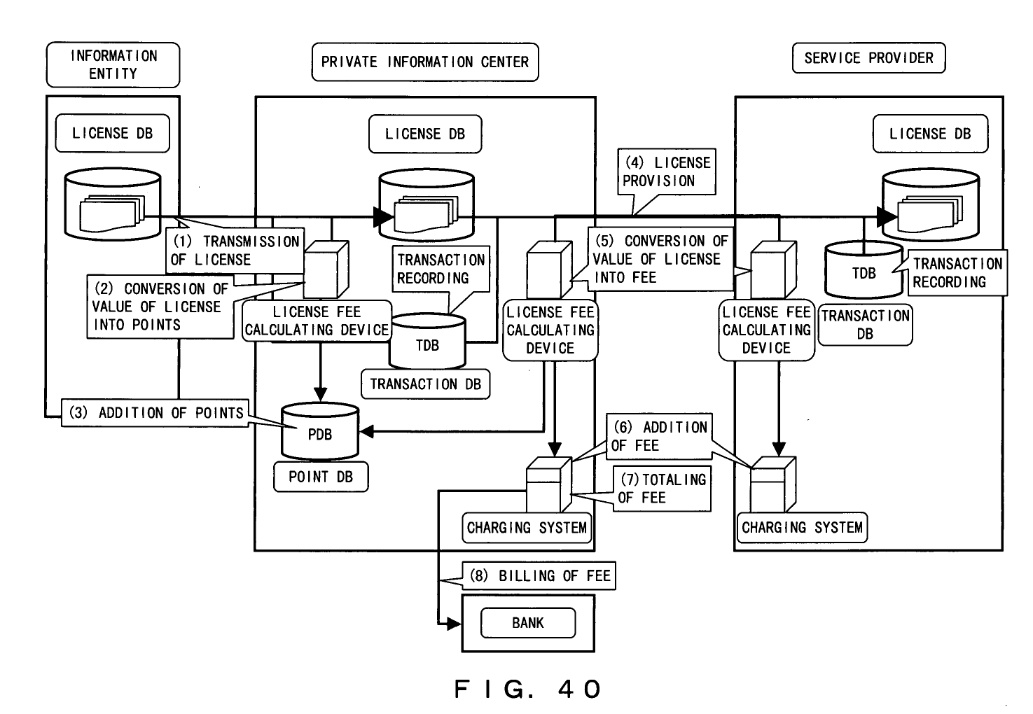

FIG. 40 shows a data flow.

It is assumed that the private information center and the service provider already have encrypted private data. It is also assumed that the information entity makes a registration to a service provided by the center. A sequence of a data flow from the information entity to the service provider via the center at this time is as follows.

(1) transmission of a license

The information entity transmits a use license when it makes a registration to the center.

(2) conversion of the value of the license into points

With the license fee calculating device of the center, points of the received use license are calculated.

(3) points addition

The points calculated in (2) are added to accumulated points stored in a point database, and a point update is made.

(4) license provision

The center transmits the use license to the service provider that makes a request.

If transmission/reception of the license is made to/from the license database system, it is recorded to a transaction database.

(5) conversion of the value of the license into a fee

With the license fee calculating device of the center, points and a fee of the transmitted use license are calculated. The points are added to accumulated points of the information entity.

With the license fee calculating device of the service provider, the fee of the received use license is calculated.

(6) fee addition

The fee calculated in (5) is added to the charging system of each of the center and the service provider.

(7) fee totaling

The charging system of the center calculates an amount of money to be charged by totaling amount data.

(8) fee billing

The charging system charges the fee to a bank contracted by the center.

According to the present invention, even if a private information management stipulation is not determined in detail within a provider (although it is necessary that at least only a particular employee is given a right to access a private data database), an illegal use and a use outside purpose of private data are protected.

According to the present invention, an information entity can provide its private data without anxiety if a server device is installed, even if a provider that handles and provides private data to be provided is not particularly trusted by the general public.

What is claimed is:

1. A private data protection distribution method, comprising:
receiving encrypted private data;
receiving an encrypted private data use license which describes a decryption key for decrypting the private data, and a use condition of the private data;
decrypting the decryption key and the private data use license;
determining whether or not a use purpose of the private data matches the use condition described in the private data use license; and
decrypting the private data by using the decrypted decryption key only if the use purpose of the private data matches the use condition.

2. The private data protection distribution method according to claim 1, wherein
the decryption key and the private data use license are encrypted and decrypted by using a DRM authentication technology.

3. The private data protection distribution method according to claim 2, wherein
a mechanism for decrypting the private data use license by using a DRM authentication technology is implemented as a TRM.

4. The private data protection distribution method according to claim 1, wherein
the use condition of the private data use license includes at least any of an expiry date, a number of available times, a use purpose, and a number of move times of the private data use license.

5. The private data protection distribution method according to claim 4, wherein
the use purpose includes a restriction on an application which uses the private data.

6. The private data protection distribution method according to claim 1, further comprising:
receiving the encrypted private data, and the encrypted private data use license which describes the decryption key for decrypting the private data, and the use condition of the private data from a plurality of information entities;
creating a name list license by concatenating a plurality of private data use licenses which have same conditions; and
creating a name list by concatenating encrypted private data which correspond to the private use licenses used to create the name list license.

7. The private data protection distribution method according to claim 6, wherein
the encrypted private data can be decrypted with a decryption key possessed by an information entity that transmits the private data.

8. The private data protection distribution method according to claim 6, wherein
if the private data is provided to a different information device, at least any one of a name, a type, a use purpose, and an inquiry destination of an organization which manages a different information device to which the private data is provided, and a provided item list of a private data database is created for each information entity, and disclosed to a corresponding information entity depending on need.

9. The private data protection distribution method according to claim 8, further comprising:
receiving corrected contents if a correction is made to at least one of the encrypted private data, and the private data use license which describes the decryption key for decrypting the private data, and the use condition of the private data; and
transmitting the corrected contents to a different information device to secure sameness of the private data and the private data use license.

10. A private data protection distribution program for causing a computer to execute a process, the process comprising:
receiving encrypted private data;
receiving an encrypted private data use license which describes a decryption key for decrypting the private data, and a use condition of the private data;
decrypting the decryption key and the private data use license;
determining whether or not a use purpose of the private data matches the use condition described in the private data use license; and
decrypting the private data by using the decrypted decryption key only if the use purpose of the private data matches the use condition.

11. A private data protection distribution apparatus, comprising:
a unit receiving encrypted private data;
a unit receiving an encrypted private data use license which describes a decryption key for decrypting the private data, and a use condition of the private data;
a unit decrypting the decryption key and the private data use license;
a unit determining whether or not a use purpose of the private data matches the use condition described in the private data use license; and
a unit decrypting the private data by using the decrypted decryption key only if the use purpose of the private data matches the use condition.
